(19) United States
(12) Patent Application Publication
(10) Pub. No.: US 2026/0149828 A1
(43) Pub. Date: May 28, 2026

(54) VIDEO SIGNAL ENCODING/DECODING METHOD AND APPARATUS BASED ON INTRA PREDICTION, AND RECORDING MEDIUM STORING BITSTREAM

(71) Applicant: KT CORPORATION, Gyeonggi-do (KR)

(72) Inventor: Sung Won LIM, Gyeonggi-do (KR)

(73) Assignee: KT CORPORATION, Gyeonggi-do (KR)

(21) Appl. No.: 19/372,190

(22) Filed: Oct. 28, 2025

Related U.S. Application Data
(63) Continuation of application No. 18/569,430, now abandoned.

(30) Foreign Application Priority Data
Jun. 29, 2021 (KR) 10-2021-0085117

(51) Int. Cl. H04N 19/593; H04N 19/11; H04N 19/119; H04N 19/136; H04N 19/176

(52) U.S. Cl. CPC H04N 19/593; H04N 19/11; H04N 19/119; H04N 19/136; H04N 19/176

(57) ABSTRACT

A video encoding/decoding method and apparatus according to the present disclosure may: determine a current block via tree structure-based block partition; determine an intra prediction mode of the current block on the basis of an MPM list of the current block; derive a reference pixel for intra prediction of the current block; and carry out intra prediction of the current block on the basis of the intra prediction mode and the reference pixel.

### TECHNICAL FIELD

The present disclosure relates to a method and a device for processing a video signal.

### BACKGROUND ART

Recently, demands for high-resolution and high-quality images such as HD (High Definition) images and UHD (Ultra High Definition) images have increased in a variety of application fields. As image data becomes high-resolution and high-quality, the volume of data relatively increases compared to the existing image data, so when image data is transmitted by using media such as the existing wire and wireless broadband circuit or is stored by using the existing storage medium, expenses for transmission and expenses for storage increase. High efficiency image compression technologies may be utilized to resolve these problems which are generated as image data becomes high-resolution and high-quality.

There are various technologies such as an inter prediction technology which predicts a pixel value included in a current picture from a previous or subsequent picture of a current picture with an image impression technology, an intra prediction technology which predicts a pixel value included in a current picture by using pixel information in a current picture, an entropy encoding technology which assigns a short sign to a value with high appearance frequency and assigns a long sign to a value with low appearance frequency and so on, and image data may be effectively compressed and transmitted or stored by using these image compression technologies.

On the other hand, as demands for a high-resolution image have increased, demands for stereo-scopic image contents have increased as a new image service. A video compression technology for effectively providing high-resolution and ultra high-resolution stereo-scopic image contents has been discussed.

### DISCLOSURE

### Technical Problem

The present disclosure intends to provide a block partition method and device in a tree structure.

The present disclosure intends to provide a method and a device for deriving an intra prediction mode for intra prediction.

The present disclosure intends to provide a method and a device for deriving an extended reference pixel for intra prediction.

The present disclosure intends to provide a method and a device for generating a prediction block based on one or more intra prediction modes.

Technical effects of the present disclosure may be non-limited by the above-mentioned technical effects, and other unmentioned technical effects may be clearly understood from the following description by those having ordinary skill in the technical field to which the present disclosure pertains.

### Technical Solution

An image decoding method according to the present disclosure may include determining a current block through tree structure-based block partition, deriving an intra prediction mode of the current block based on a MPM list of the current block, deriving a reference pixel for intra prediction of the current block and performing intra prediction of the current block based on the intra prediction mode and the reference pixel.

In an image decoding method according to the present disclosure, the tree structure-based block partition may include at least one of penta-tree partition or quad-tree partition.

In an image decoding method according to the present disclosure, the quad-tree partition partitions a coding block into 4 coding blocks in one of a vertical direction or a horizontal direction and the quad-tree partition may be performed by selectively using one of a plurality of partition types having a predetermined partition ratio.

In an image decoding method according to the present disclosure, a MPM list of the current block includes a plurality of MPM candidates and at least one of the plurality of MPM candidates may be derived by using at least one of a left-middle block, a top-center block, a right block or a bottom block of the current block.

In an image decoding method according to the present disclosure, at least two intra prediction modes may be derived from the MPM list.

In an image decoding method according to the present disclosure, performing intra prediction of the current block may include generating a first prediction block of the current block based on one of the at least two intra prediction modes, generating a second prediction block of the current block based on the other of the at least two intra prediction modes and generating a final prediction block of the current block through a weighted sum of the first prediction block and the second prediction block.

In an image decoding method according to the present disclosure, the current block may be partitioned into a plurality of partitions including a first partition and a second partition, one of the at least two intra prediction modes may be configured as an intra prediction mode of the first partition and the other of the at least two intra prediction modes may be configured as an intra prediction mode of the second partition.

In an image decoding method according to the present disclosure, a weight for a weighted sum between the first prediction block and the second prediction block may be derived based on a predetermined weight matrix and the weight matrix may be adaptively derived based on at least one of a partition direction of a partition line partitioning the current block or a distance from the center of the current block to the partition line.

In an image decoding method according to the present disclosure, a weight for a weighted sum between the first prediction block and the second prediction block may be derived based on a weight list including a plurality of weight candidates which are pre-defined in a decoding device.

In an image decoding method according to the present disclosure, only one of at least two intra prediction modes for the current block may be selectively stored.

An image encoding method according to the present disclosure may include determining a current block through tree structure-based block partition, determining an intra prediction mode of the current block based on a MPM list of the current block, deriving a reference pixel for intra prediction of the current block and performing intra prediction of the current block based on the intra prediction mode and the reference pixel.

In an image encoding method according to the present disclosure, the tree structure-based block partition may include at least one of penta-tree partition or quad-tree partition.

In an image encoding method according to the present disclosure, the quad-tree partition partitions a coding block into 4 coding blocks in one of a vertical direction or a horizontal direction and the quad-tree partition may be performed by selectively using one of a plurality of partition types having a predetermined partition ratio.

In an image encoding method according to the present disclosure, a MPM list of the current block includes a plurality of MPM candidates and at least one of the plurality of MPM candidates may be derived by using at least one of a left-middle block, a top-center block, a right block or a bottom block of the current block.

In an image encoding method according to the present disclosure, at least two intra prediction modes may be determined from the MPM list.

In an image encoding method according to the present disclosure, performing intra prediction of the current block may include generating a first prediction block of the current block based on one of the at least two intra prediction modes, generating a second prediction block of the current block based on the other of the at least two intra prediction modes and generating a final prediction block of the current block through a weighted sum of the first prediction block and the second prediction block.

In an image encoding method according to the present disclosure, the current block may be partitioned into a plurality of partitions including a first partition and a second partition, one of the at least two intra prediction modes may be configured as an intra prediction mode of the first partition and the other of the at least two intra prediction modes may be configured as an intra prediction mode of the second partition.

In an image encoding method according to the present disclosure, a weight for a weighted sum between the first prediction block and the second prediction block may be derived based on a predetermined weight matrix and the weight matrix may be adaptively derived based on at least one of a partition direction of a partition line partitioning the current block or a distance from the center of the current block to the partition line.

In an image encoding method according to the present disclosure, a weight for a weighted sum between the first prediction block and the second prediction block may be derived based on a weight list including a plurality of weight candidates which are pre-defined in a decoding device.

In an image encoding method according to the present disclosure, only one of at least two intra prediction modes for the current block may be selectively stored.

A computer readable recording medium according to the present disclosure may store a bitstream generated by an image encoding method described above or decoded by an image decoding method.

A computing device according to the present disclosure may store a program (instructions) for transmitting a bitstream generated by an image encoding method described above.

Features briefly summarized above with respect to the present disclosure are just an exemplary aspect of a detailed description of the present disclosure described below, and they do not limit a scope of the present disclosure.

### Technical Effect

According to the present disclosure, a size and a shape of a coding block, a prediction block or a transform block may be effectively determined through block partition in various tree structures.

According to the present disclosure, encoding efficiency of intra prediction may be improved by using an extended MPM candidate and a reference pixel as a basis.

According to the present disclosure, encoding efficiency may be improved through weighted prediction-based intra prediction.

According to the present disclosure, complexity of hardware implementation may be reduced by selectively storing a plurality of intra prediction modes for weighted prediction.

Effects obtainable from the present disclosure are not limited to the above-mentioned effects and other unmentioned effects may be clearly understood from the following description by those having ordinary skill in the technical field to which the present disclosure pertains.

### BRIEF DESCRIPTION OF DRAWINGS

FIG. 1 is a block diagram showing an image encoding device according to an embodiment of the present disclosure.

FIG. 2 is a block diagram showing an image decoding device according to an embodiment of the present disclosure.

FIGS. 3 to 12 show a block partition method according to the present disclosure.

FIGS. 13 to 17 show encoding order according to a block partition method according to the present disclosure.

FIG. 18 shows an intra prediction method in an encoding/decoding device according to the present disclosure.

As an embodiment to which the present disclosure is applied, FIGS. 19 and 20 show predefined intra prediction modes available for a current block.

As an embodiment to which the present disclosure is applied, FIG. 21 shows a scope of an intra prediction mode which may be used by a partition in a current block.

As an embodiment to which the present disclosure is applied, FIGS. 22 and 23 show a surrounding reference position used when configuring a MPM list.

As an embodiment to which the present disclosure is applied, FIGS. 24 to 29 show a method of deriving a reference pixel.

As an embodiment to which the present disclosure is applied, FIGS. 30 to 34 show a method of generating a prediction pixel per intra prediction mode.

As an embodiment to which the present disclosure is applied, FIGS. 35 and 36 show a method of partitioning a current block into a plurality of partitions.

As an embodiment to which the present disclosure is applied, FIG. 37 shows an example for a method of obtaining a prediction pixel by using a different intra prediction mode per each partition of a current block.

As an embodiment to which the present disclosure is applied, FIG. 38 shows an example of a weight matrix applied to a 8×8 block.

As an embodiment to which the present disclosure is applied, FIGS. 39 and 40 are an example showing a storage unit of a current block which is partitioned into two partitions and encoded.

As an embodiment to which the present disclosure is applied, FIG. 41 shows a method of generating a prediction pixel of a current block based on two intra prediction modes for a current block.

As an embodiment to which the present disclosure is applied, FIG. 42 shows a weight allocation method according to an intra prediction mode of a surrounding block.

### BEST MODE

An image decoding method according to the present disclosure may include determining a current block through tree structure-based block partition, deriving an intra prediction mode of the current block based on a MPM list of the current block, deriving a reference pixel for intra prediction of the current block and performing intra prediction of the current block based on the intra prediction mode and the reference pixel.

In an image decoding method according to the present disclosure, the tree structure-based block partition may include at least one of penta-tree partition or quad-tree partition.

In an image decoding method according to the present disclosure, the quad-tree partition partitions a coding block into 4 coding blocks in one of a vertical direction or a horizontal direction and the quad-tree partition may be performed by selectively using one of a plurality of partition types having a predetermined partition ratio.

In an image decoding method according to the present disclosure, a MPM list of the current block includes a plurality of MPM candidates and at least one of the plurality of MPM candidates may be derived by using at least one of a left-middle block, a top-center block, a right block or a bottom block of the current block.

In an image decoding method according to the present disclosure, at least two intra prediction modes may be derived from the MPM list.

In an image decoding method according to the present disclosure, performing intra prediction of the current block may include generating a first prediction block of the current block based on one of the at least two intra prediction modes, generating a second prediction block of the current block based on the other of the at least two intra prediction modes and generating a final prediction block of the current block through a weighted sum of the first prediction block and the second prediction block.

In an image decoding method according to the present disclosure, the current block may be partitioned into a plurality of partitions including a first partition and a second partition, one of the at least two intra prediction modes may be configured as an intra prediction mode of the first partition and the other of the at least two intra prediction modes may be configured as an intra prediction mode of the second partition.

In an image decoding method according to the present disclosure, a weight for a weighted sum between the first prediction block and the second prediction block may be derived based on a predetermined weight matrix and the weight matrix may be adaptively derived based on at least one of a partition direction of a partition line partitioning the current block or a distance from the center of the current block to the partition line.

In an image decoding method according to the present disclosure, a weight for a weighted sum between the first prediction block and the second prediction block may be derived based on a weight list including a plurality of weight candidates which are pre-defined in a decoding device.

In an image decoding method according to the present disclosure, only one of at least two intra prediction modes for the current block may be selectively stored.

An image encoding method according to the present disclosure may include determining a current block through tree structure-based block partition, determining an intra prediction mode of the current block based on a MPM list of the current block, deriving a reference pixel for intra prediction of the current block and performing intra prediction of the current block based on the intra prediction mode and the reference pixel.

In an image encoding method according to the present disclosure, the tree structure-based block partition may include at least one of penta-tree partition or quad-tree partition.

In an image encoding method according to the present disclosure, the quad-tree partition partitions a coding block into 4 coding blocks in one of a vertical direction or a horizontal direction and the quad-tree partition may be performed by selectively using one of a plurality of partition types having a predetermined partition ratio.

In an image encoding method according to the present disclosure, a MPM list of the current block includes a plurality of MPM candidates and at least one of the plurality of MPM candidates may be derived by using at least one of a left-middle block, a top-center block, a right block or a bottom block of the current block.

In an image encoding method according to the present disclosure, at least two intra prediction modes may be determined from the MPM list.

In an image encoding method according to the present disclosure, performing intra prediction of the current block may include generating a first prediction block of the current block based on one of the at least two intra prediction modes, generating a second prediction block of the current block based on the other of the at least two intra prediction modes and generating a final prediction block of the current block through a weighted sum of the first prediction block and the second prediction block.

In an image encoding method according to the present disclosure, the current block may be partitioned into a plurality of partitions including a first partition and a second partition, one of the at least two intra prediction modes may be configured as an intra prediction mode of the first partition and the other of the at least two intra prediction modes may be configured as an intra prediction mode of the second partition.

In an image encoding method according to the present disclosure, a weight for a weighted sum between the first prediction block and the second prediction block may be derived based on a predetermined weight matrix and the weight matrix may be adaptively derived based on at least one of a partition direction of a partition line partitioning the current block or a distance from the center of the current block to the partition line.

In an image encoding method according to the present disclosure, a weight for a weighted sum between the first prediction block and the second prediction block may be derived based on a weight list including a plurality of weight candidates which are pre-defined in a decoding device.

In an image encoding method according to the present disclosure, only one of at least two intra prediction modes for the current block may be selectively stored.

A computer readable recording medium according to the present disclosure may store a bitstream generated by an image encoding method described above or decoded by an image decoding method.

A computing device according to the present disclosure may store a program (instructions) for transmitting a bitstream generated by an image encoding method described above.

Features briefly summarized above with respect to the present disclosure are just an exemplary aspect of a detailed description of the present disclosure described below, and they do not limit a scope of the present disclosure.

### DETAILED DESCRIPTION OF THE DISCLOSURE

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference numeral was used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term of and/or includes a combination of a plurality of relative entered items or any item of a plurality of relative entered items.

When a component is referred to as being “linked” or “connected” to other component, it should be understood that it may be directly linked or connected to that other component, but other component may exist in the middle. On the other hand, when a component is referred to as being “directly linked” or “directly connected” to other component, it should be understood that other component does not exist in the middle.

As terms used in this application are just used to describe a specific embodiment, they are not intended to limit the present disclosure. Expression of the singular includes expression of the plural unless it clearly has a different meaning contextually. In this application, it should be understood that a term such as “include” or “have”, etc. is to designate the existence of characteristics, numbers, steps, motions, components, parts or their combinations entered in the specification, but is not to exclude a possibility of addition or existence of one or more other characteristics, numbers, steps, motions, components, parts or their combinations in advance.

Hereinafter, referring to the attached drawings, a desirable embodiment of the present disclosure will be described in more detail. Hereinafter, the same reference numeral is used for the same component in a drawing and an overlapping description for the same component is omitted.

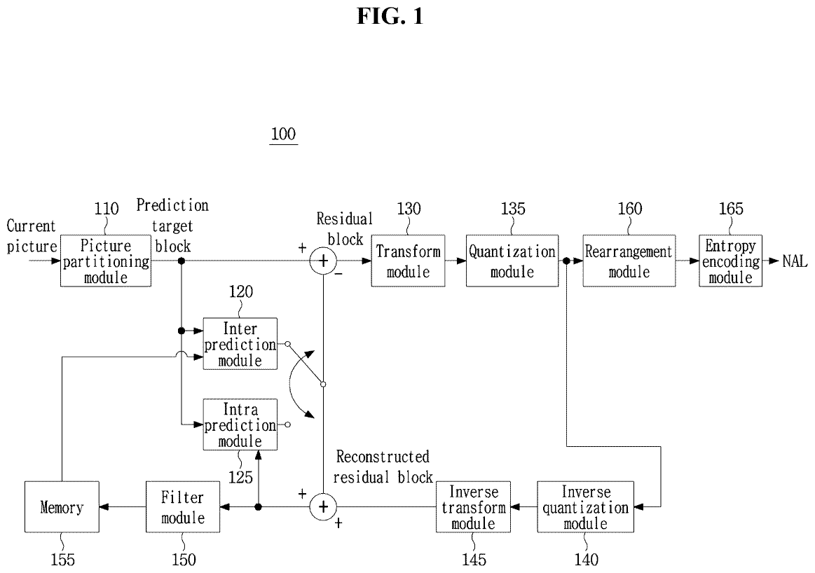

FIG. 1 is a block diagram showing an image encoding device according to an embodiment of the present disclosure.

Referring to FIG. 1, an image encoding device 100 may include a picture partitioning unit 110, prediction units 120 and 125, a transform unit 130, a quantization unit 135, a rearrangement unit 160, an entropy encoding unit 165, a dequantization unit 140, an inverse-transform unit 145, a filter unit 150, and a memory 155.

As each construction unit shown in FIG. 1 is independently shown to represent different characteristic functions in an image encoding device, it does not mean that each construction unit is constituted by separated hardware or one software unit. That is, as each construction unit is included by being enumerated as each construction unit for convenience of a description, at least two construction units of each construction unit may be combined to constitute one construction unit or one construction unit may be partitioned into a plurality of construction units to perform a function, and even an integrated embodiment and a separated embodiment of each construction unit are also included in a scope of a right of the present disclosure unless they are departing from the essence of the present disclosure.

Further, some components may be just an optional component for improving performance, not a necessary component which perform an essential function in the present disclosure. The present disclosure may be implemented by including only a construction unit necessary for implementing the essence of the present disclosure excluding a component used to just improve performance, and a structure including only a necessary component excluding an optional component used to just improve performance is also included in a scope of a right of the present disclosure.

A picture partitioning unit 110 may partition an input picture into at least one processing unit. In this case, a processing unit may be a prediction unit (PU), a transform unit (TU) or a coding unit (CU). In a picture partitioning unit 110, one picture may be partitioned into a combination of a plurality of coding units, prediction units and transform units and a picture may be encoded by selecting a combination of one coding unit, prediction unit and transform unit according to a predetermined standard (e.g., a cost function).

For example, one picture may be partitioned into a plurality of coding units. In order to partition a coding unit in a picture, a recursive tree structure such as a quad tree, a ternary tree or a binary tree may be used, and a coding unit which is partitioned into other coding units by using one image or the largest coding unit as a route may be partitioned with as many child nodes as the number of partitioned coding units. A coding unit which is no longer partitioned according to a certain restriction becomes a leaf node. In an example, when it is assumed that quad tree partitioning is applied to one coding unit, one coding unit may be partitioned into up to four other coding units.

Hereinafter, in an embodiment of the present disclosure, a coding unit may be used as a unit for encoding or may be used as a unit for decoding.

A prediction unit may be partitioned with at least one square or rectangular shape, etc. in the same size in one coding unit or may be partitioned so that any one prediction unit of prediction units partitioned in one coding unit can have a shape and/or a size different from another prediction unit.

In intra prediction, a transform unit may be configured to be the same as a prediction unit. In this case, after partitioning a coding unit into a plurality of transform units, intra prediction may be performed per each transform unit. A coding unit may be partitioned in a horizontal direction or in a vertical direction. The number of transform units generated by partitioning a coding unit may be 2 or 4 according to a size of a coding unit.

Prediction units 120 and 125 may include an inter prediction unit 120 performing inter prediction and an intra prediction unit 125 performing intra prediction. Whether to perform inter prediction or intra prediction for a coding unit may be determined and detailed information according to each prediction method (e.g., an intra prediction mode, a motion vector, a reference picture, etc.) may be determined. In this case, a processing unit that prediction is performed may be different from a processing unit that a prediction method and details are determined. For example, a prediction method, a prediction mode, etc. may be determined in a coding unit and prediction may be performed in a prediction unit or a transform unit. A residual value (a residual block) between a generated prediction block and an original block may be input to a transform unit 130. In addition, prediction mode information, motion vector information, etc. used for prediction may be encoded with a residual value in an entropy encoding unit 165 and may be transmitted to a decoding device. When a specific encoding mode is used, an original block may be encoded as it is and transmitted to a decoding unit without generating a prediction block through prediction units 120 or 125.

An inter prediction unit 120 may predict a prediction unit based on information on at least one picture of a previous picture or a subsequent picture of a current picture, or in some cases, may predict a prediction unit based on information on some encoded regions in a current picture. An inter prediction unit 120 may include a reference picture interpolation unit, a motion prediction unit and a motion compensation unit.

A reference picture interpolation unit may receive reference picture information from a memory 155 and generate pixel information equal to or less than an integer pixel in a reference picture. For a luma pixel, a 8-tap DCT-based interpolation filter having a different filter coefficient may be used to generate pixel information equal to or less than an integer pixel in a ¼ pixel unit. For a chroma signal, a 4-tap DCT-based interpolation filter having a different filter coefficient may be used to generate pixel information equal to or less than an integer pixel in a ⅛ pixel unit.

A motion prediction unit may perform motion prediction based on a reference picture interpolated by a reference picture interpolation unit. As a method for calculating a motion vector, various methods such as FBMA (Full search-based Block Matching Algorithm), TSS (Three Step Search), NTS (New Three-Step Search Algorithm), etc. may be used. A motion vector may have a motion vector value in a ½ or ¼ pixel unit based on an interpolated pixel. A motion prediction unit may predict a current prediction unit by varying a motion prediction method. As a motion prediction method, various methods such as a skip method, a merge method, an advanced motion vector prediction (AMVP) method, an intra block copy method, etc. may be used.

An intra prediction unit 125 may generate a prediction unit based on reference pixel information which is pixel information in a current picture. Reference pixel information may be derived from selected one of a plurality of reference pixel lines. A N-th reference pixel line among a plurality of reference pixel lines may include left pixels whose x-axis difference with a top-left pixel in a current block is N and top pixels whose y-axis difference with the top-left pixel is N. The number of reference pixel lines which may be selected by a current block may be 1, 2, 3 or 4.

When a neighboring block in a current prediction unit is a block which performed inter prediction and accordingly, a reference pixel is a pixel which performed inter prediction, a reference pixel included in a block which performed inter prediction may be used by being replaced with reference pixel information of a surrounding block which performed intra prediction. In other words, when a reference pixel is unavailable, unavailable reference pixel information may be used by being replaced with at least information of available reference pixels.

A prediction mode in intra prediction may have a directional prediction mode using reference pixel information according to a prediction direction and a non-directional mode not using directional information when performing prediction. A mode for predicting luma information may be different from a mode for predicting chroma information and intra prediction mode information used for predicting luma information or predicted luma signal information may be utilized to predict chroma information.

When a size of a prediction unit is the same as that of a transform unit in performing intra prediction, intra prediction for a prediction unit may be performed based on a pixel at a left position of a prediction unit, a pixel at a top-left position and a pixel at a top position.

An intra prediction method may generate a prediction block after applying a smoothing filter to a reference pixel according to a prediction mode. According to a selected reference pixel line, whether a smoothing filter is applied may be determined.

In order to perform an intra prediction method, an intra prediction mode in a current prediction unit may be predicted from an intra prediction mode in a prediction unit around a current prediction unit. When a prediction mode in a current prediction unit is predicted by using mode information predicted from a surrounding prediction unit, information that a prediction mode in a current prediction unit is the same as a prediction mode in a surrounding prediction unit may be transmitted by using predetermined flag information if an intra prediction mode in a current prediction unit is the same as an intra prediction mode in a surrounding prediction unit, and prediction mode information of a current block may be encoded by performing entropy encoding if a prediction mode in a current prediction unit is different from a prediction mode in a surrounding prediction unit.

In addition, a residual block may be generated which includes information on a residual value that is a difference value between a prediction unit which performed prediction based on a prediction unit generated in prediction units 120 and 125 and an original block in a prediction unit. A generated residual block may be input to a transform unit 130.

A transform unit 130 may transform an original block and a residual block including residual value information in a prediction unit generated through prediction units 120 and 125 by using a transform method such as DCT (Discrete Cosine Transform), DST (Discrete Sine Transform), KLT. Whether to apply DCT, DST or KLT to transform a residual block may be determined based on at least one of a size of a transform unit, a form of a transform unit, a prediction mode in a prediction unit or intra prediction mode information in a prediction unit.

A quantization unit 135 may quantize values transformed into a frequency domain in a transform unit 130. A quantization coefficient may be changed according to a block or importance of an image. A value calculated in a quantization unit 135 may be provided to a dequantization unit 140 and a rearrangement unit 160.

A rearrangement unit 160 may perform rearrangement of a coefficient value for a quantized residual value.

A rearrangement unit 160 may change a coefficient in a shape of a two-dimensional block into a shape of a one-dimensional vector through a coefficient scan method. For example, a rearrangement unit 160 may scan a DC coefficient to a coefficient in a high-frequency domain by using a zig-zag scan method and change it into a shape of a one-dimensional vector. According to a size of a transform unit and an intra prediction mode, instead of zig-zag scan, vertical scan where a coefficient in a shape of a two-dimensional block is scanned in a column direction, horizontal scan where a coefficient in a shape of a two-dimensional block is scanned in a row direction or diagonal scan where a coefficient in a shape of a two-dimensional block is scanned in a diagonal direction may be used. In other words, which scan method among zig-zag scan, vertical directional scan, horizontal directional scan or diagonal scan will be used may be determined according to a size of a transform unit and an intra prediction mode.

An entropy encoding unit 165 may perform entropy encoding based on values calculated by a rearrangement unit 160. Entropy encoding, for example, may use various encoding methods such as exponential Golomb, CAVLC (Context-Adaptive Variable Length Coding), CABAC (Context-Adaptive Binary Arithmetic Coding).

An entropy encoding unit 165 may encode a variety of information such as residual value coefficient information and block type information in a coding unit, prediction mode information, partitioning unit information, prediction unit information and transmission unit information, motion vector information, reference frame information, block interpolation information, filtering information, etc. from a rearrangement unit 160 and prediction units 120 and 125.

An entropy encoding unit 165 may perform entropy encoding for a coefficient value in a coding unit which is input from a rearrangement unit 160.

A dequantization unit 140 and an inverse transform unit 145 dequantize values quantized in a quantization unit 135 and inversely transform values transformed in a transform unit 130. A residual value generated by a dequantization unit 140 and an inverse transform unit 145 may be combined with a prediction unit predicted by a motion prediction unit, a motion compensation unit and an intra prediction unit included in prediction units 120 and 125 to generate a reconstructed block.

A filter unit 150 may include at least one of a deblocking filter, an offset correction unit and an adaptive loop filter (ALF).

A deblocking filter may remove block distortion which is generated by a boundary between blocks in a reconstructed picture. In order to determine whether deblocking is performed, whether a deblocking filter will be applied to a current block may be determined based on a pixel included in several rows or columns included in a block. When a deblocking filter is applied to a block, a strong filter or a weak filter may be applied according to required deblocking filtering strength. In addition, in applying a deblocking filter, when horizontal filtering and vertical filtering are performed, horizontal directional filtering and vertical directional filtering may be set to be processed in parallel.

An offset correction unit may correct an offset with an original image in a unit of a pixel for an image that deblocking was performed. In order to perform offset correction for a specific picture, a region where an offset will be performed may be determined after dividing a pixel included in an image into the certain number of regions and a method in which an offset is applied to a corresponding region or a method in which an offset is applied by considering edge information of each pixel may be used.

Adaptive loop filtering (ALF) may be performed based on a value obtained by comparing a filtered reconstructed image with an original image. After a pixel included in an image is divided into predetermined groups, filtering may be discriminately performed per group by determining one filter which will be applied to a corresponding group. Information related to whether to apply ALF may be transmitted per coding unit (CU) for a luma signal and a shape and a filter coefficient of an ALF filter to be applied may vary according to each block. In addition, an ALF filter in the same shape (fixed shape) may be applied regardless of a characteristic of a block to be applied.

A memory 155 may store a reconstructed block or picture calculated through a filter unit 150 and a stored reconstructed block or picture may be provided to prediction units 120 and 125 when performing inter prediction.

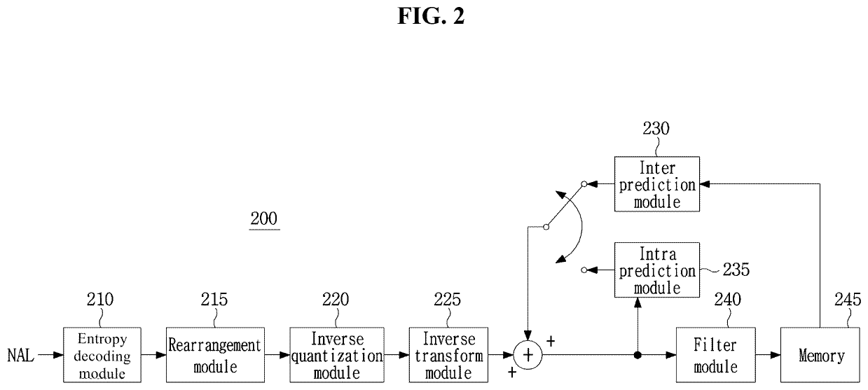

FIG. 2 is a block diagram showing an image decoding device according to an embodiment of the present disclosure.

Referring to FIG. 2, an image decoding device 200 may include an entropy decoding unit 210, a rearrangement unit 215, a dequantization unit 220, an inverse transform unit 225, prediction units 230 and 235, a filter unit 240, and a memory 245.

When an image bitstream is input from an image encoding device, an input bitstream may be decoded according to a procedure opposite to that of an image encoding device.

An entropy decoding unit 210 may perform entropy decoding according to a procedure opposite to a procedure in which entropy encoding is performed in an entropy encoding unit of an image encoding device. For example, in response to a method performed in an image encoding device, various methods such as Exponential Golomb, CAVLC (Context-Adaptive Variable Length Coding), CABAC (Context-Adaptive Binary Arithmetic Coding) may be applied.

An entropy decoding unit 210 may decode information related to intra prediction and inter prediction performed in an encoding device.

A rearrangement unit 215 may perform rearrangement based on a method that a bitstream entropy-decoded in an entropy decoding unit 210 is rearranged in an encoding unit. Coefficients expressed in a form of a one-dimensional vector may be rearranged by being reconstructed into coefficients in a form of a two-dimensional block. A rearrangement unit 215 may receive information related to coefficient scanning performed in an encoding unit and perform rearrangement through a method in which scanning is inversely performed based on scanning order performed in a corresponding encoding unit.

A dequantization unit 220 may perform dequantization based on a quantization parameter provided from an encoding device and a coefficient value of a rearranged block.

An inverse transform unit 225 may perform transform performed in a transform unit, i.e., inverse transform for DCT, DST, and KLT, i.e., inverse DCT, inverse DST and inverse KLT for a result of quantization performed in an image encoding device. Inverse transform may be performed based on a transmission unit determined in an image encoding device. In an inverse transform unit 225 of an image decoding device, a transform technique (for example, DCT, DST, KLT) may be selectively performed according to a plurality of information such as a prediction method, a size or a shape of a current block, a prediction mode, an intra prediction direction, etc.

Prediction units 230 and 235 may generate a prediction block based on information related to generation of a prediction block provided from an entropy decoding unit 210 and pre-decoded block or picture information provided from a memory 245.

As described above, when a size of a prediction unit is the same as a size of a transform unit in performing intra prediction in the same manner as an operation in an image encoding device, intra prediction for a prediction unit may be performed based on a pixel at a left position of a prediction unit, a pixel at a top-left position and a pixel at a top position, but when a size of a prediction unit is different from a size of a transform unit in performing intra prediction, intra prediction may be performed by using a reference pixel based on a transform unit. In addition, intra prediction using N×N partitioning may be used only for the smallest coding unit.

Prediction units 230 and 235 may include a prediction unit determination unit, an inter prediction unit and an intra prediction unit. A prediction unit determination unit may receive a variety of information such as prediction unit information, prediction mode information of an intra prediction method, motion prediction-related information of an inter prediction method, etc. which are input from an entropy decoding unit 210, divide a prediction unit in a current coding unit and determine whether a prediction unit performs inter prediction or intra prediction. An inter prediction unit 230 may perform inter prediction for a current prediction unit based on information included in at least one picture of a previous picture or a subsequent picture of a current picture including a current prediction unit by using information necessary for inter prediction in a current prediction unit provided from an image encoding device. Alternatively, inter prediction may be performed based on information on some regions which are pre-reconstructed in a current picture including a current prediction unit.

In order to perform inter prediction, whether a motion prediction method in a prediction unit included in a corresponding coding unit is a skip mode, a merge mode, an AMVP mode, or an intra block copy mode may be determined based on a coding unit.

An intra prediction unit 235 may generate a prediction block based on pixel information in a current picture. When a prediction unit is a prediction unit which performed intra prediction, intra prediction may be performed based on intra prediction mode information in a prediction unit provided from an image encoding device. An intra prediction unit 235 may include an adaptive intra smoothing (AIS) filter, a reference pixel interpolation unit and a DC filter. As a part performing filtering on a reference pixel of a current block, an AIS filter may be applied by determining whether a filter is applied according to a prediction mode in a current prediction unit. AIS filtering may be performed for a reference pixel of a current block by using AIS filter information and a prediction mode in a prediction unit provided from an image encoding device. When a prediction mode of a current block is a mode which does not perform AIS filtering, an AIS filter may not be applied

When a prediction mode in a prediction unit is a prediction unit which performs intra prediction based on a pixel value which interpolated a reference pixel, a reference pixel interpolation unit may interpolate a reference pixel to generate a reference pixel in a unit of a pixel equal to or less than an integer value. When a prediction mode in a current prediction unit is a prediction mode which generates a prediction block without interpolating a reference pixel, a reference pixel may not be interpolated. A DC filter may generate a prediction block through filtering when a prediction mode of a current block is a DC mode.

A reconstructed block or picture may be provided to a filter unit 240. A filter unit 240 may include a deblocking filter, an offset correction unit and ALF.

Information on whether a deblocking filter was applied to a corresponding block or picture and information on whether a strong filter or a weak filter was applied when a deblocking filter was applied may be provided from an image encoding device. Information related to a deblocking filter provided from an image encoding device may be provided in a deblocking filter of an image decoding device and deblocking filtering for a corresponding block may be performed in an image decoding device.

An offset correction unit may perform offset correction on a reconstructed image based on offset value information, a type of offset correction, etc. applied to an image when performing encoding.

ALF may be applied to a coding unit based on information on whether ALF is applied, ALF coefficient information, etc. provided from an encoding device. Such ALF information may be provided by being included in a specific parameter set.

A memory 245 may store a reconstructed picture or block for use as a reference picture or a reference block and provide a reconstructed picture to an output unit.

As described above, hereinafter, in an embodiment of the present disclosure, a coding unit is used as a term of a coding unit for convenience of a description, but it may be a unit which performs decoding as well as encoding.

In addition, as a current block represents a block to be encoded/decoded, it may represent a coding tree block (or a coding tree unit), a coding block (or a coding unit), a transform block (or a transform unit) or a prediction block (or a prediction unit) or a block to which an in-loop filter is applied, etc. according to an encoding/decoding step. In this specification, ‘unit’ may represent a base unit for performing a specific encoding/decoding process and ‘block’ may represent a pixel array in a predetermined size. Unless otherwise classified, ‘block’ and ‘unit’ may be used interchangeably. For example, in the after-described embodiment, it may be understood that a coding block (a coding block) and a coding unit (a coding unit) are used interchangeably.

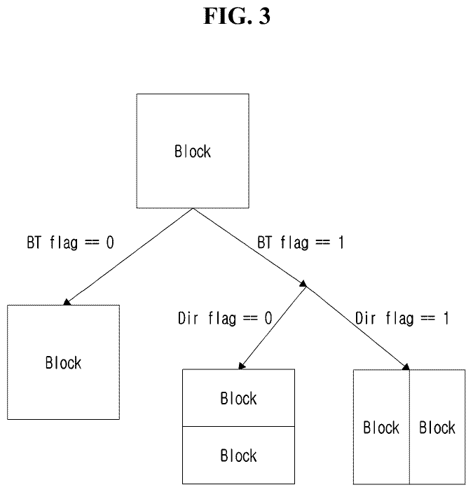

FIGS. 3 to 12 show a block partition method according to the present disclosure.

In an embodiment described later, ‘block’ is a target of encoding/decoding and may represent any one of a coding block, a prediction block or a transform block.

One block may be partitioned into a plurality of blocks having various sizes and shapes through a tree structure. A partitioned block may be also partitioned again into a plurality of blocks having various sizes and shapes. As such, recursively partitioning a block may be defined as ‘tree structure’-based partition.

The tree structure-based partition may be performed based on predetermined partition information. Here, partition information may be encoded in an encoding device and transmitted through a bitstream or may be derived from an encoding/decoding device. The partition information may include information indicating whether to partition a block (hereinafter, referred to as a partition flag). When a partition flag indicates partition of a block, a block is partitioned and moved to the next block according to encoding order. Here, the next block refers to a block that encoding will be performed first among partitioned blocks. When a partition flag indicates that a block is not partitioned, encoding information of a block is encoded to move to the next block according to whether the next block exists or terminate a partition process of a block.

Partition information may include information on tree partition. Hereinafter, a tree partition method used for block partition is described.

A binary tree (BT) partition method is a method of partitioning a block into two parts. Blocks generated by two partitions may have the same size. FIG. 3 shows an example that BT partition is performed on a block through a BT flag.

Whether to partition a block may be determined through a BT flag. In an example, when a BT flag is 0, BT partition is terminated. On the other hand, when a BT flag is 1, a block may be partitioned into two blocks by using a Dir flag which indicates a partition direction.

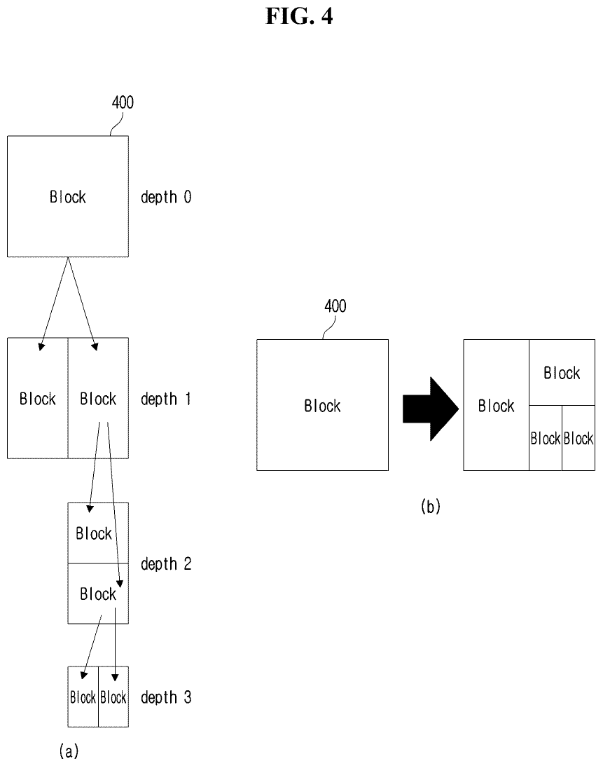

In addition, a partitioned block may be expressed as depth information. FIG. 4 shows an example of depth information.

FIG. 4(a) is an example showing a process in which a block 400 is partitioned through BT partition and a value of depth information. Each time a block is partitioned, a value of depth information may increase by 1. When a block of Depth Nis partitioned into blocks of depth (N+1), a block of Depth N is referred to as a parent block of blocks of depth (N+1). Conversely, a block of Depth (N+1) is referred to as a child block of a block of depth N. It may be equally applied in a tree structure described later. FIG. 4(b) shows a finally partitioned shape when a block 400 is partitioned by using a BT as in (a).

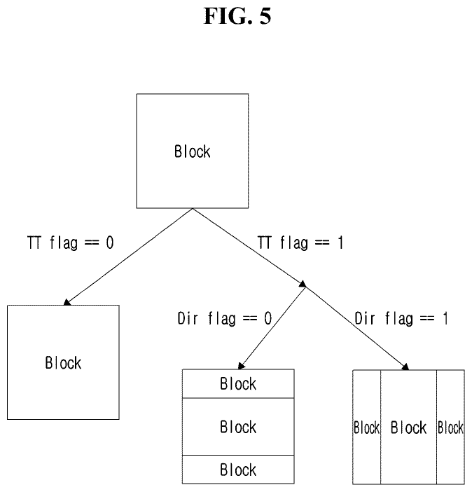

A ternary-tree (TT) partition method is a method of partitioning a block into three parts. In this case, child blocks may have a ratio of 1:2:1. FIG. 5 shows an example in which TT partition is performed on a block through a TT flag.

Whether to partition a block may be determined through a TT flag. In an example, when a TT flag is 0, TT partition is terminated. On the other hand, when a TT flag is 1, a block may be partitioned into three parts in a horizontal direction or in a vertical direction by using a Dir flag.

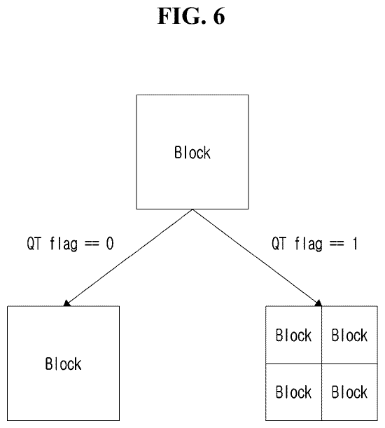

A quad-tree (QT) partition method is a method of partitioning a block into four parts. Four child blocks may have the same size. FIG. 6 shows an example in which QT partition is performed on a block through a QT flag.

Whether to partition a block may be determined through a QT flag. In an example, when a QT flag is 0, QT partition is terminated. On the other hand, when a QT flag is 1, a block may be partitioned into four parts.

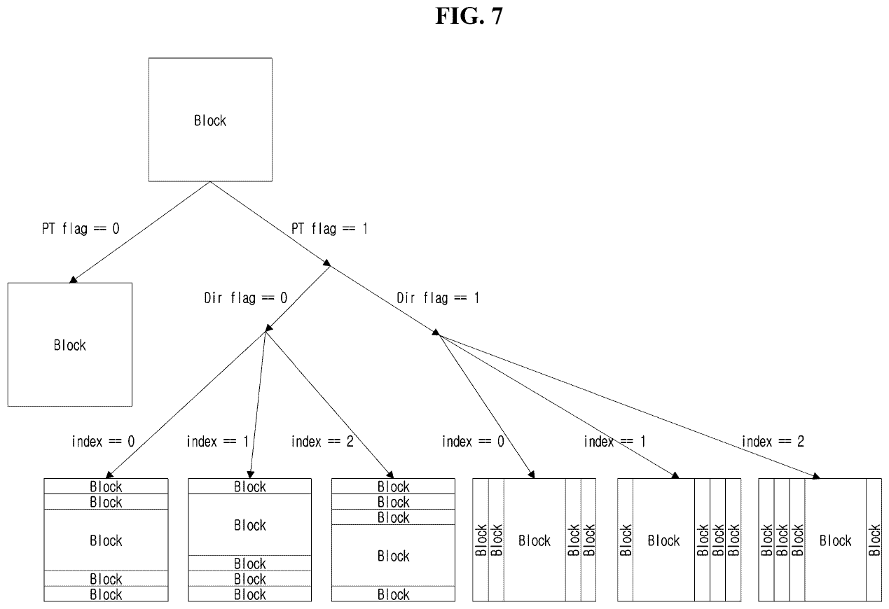

One block may be partitioned in various ways other than BT partition, TT partition and QT partition according to FIGS. 4 to 6. In an example, a method of partitioning one block into five child blocks may be applied. FIG. 7 shows an example of a PT partition method in which a block is partitioned into five parts by using a penta-tree (PT) flag.

Whether to partition a block into five parts may be determined through a PT flag for a block. When a PT flag is 0, PT partition is terminated. When a PT flag is 1, in which direction of a horizontal direction or a vertical direction partition is performed may be determined by using a Dir flag indicating a partition direction.

In addition, a partition type may be indicated by using an index. When five partitions are applied, four child blocks may have the same size and the remaining one child block may have a size four times that of other child blocks. In this case, a position of a child block which is larger than other child blocks may be indicated by an index. In other words, the index may be defined as specifying one of a plurality of PT partition types which are predefined in an encoding/decoding device or specifying a position of the largest child block of five child blocks.

A plurality of PT partition types may include a first type with a partition ratio of 1:1:4:1:1, a second type with a partition cost of 1:4:1:1:1 and a third type with a partition ratio of 1:1:1:4:1. As shown in FIG. 7, partition may be performed at a ratio of 1:1:4:1:1, 1:4:1:1:1 or 1:1:1:4:1, respectively, according to a value of an index, i.e., 0 to 2.

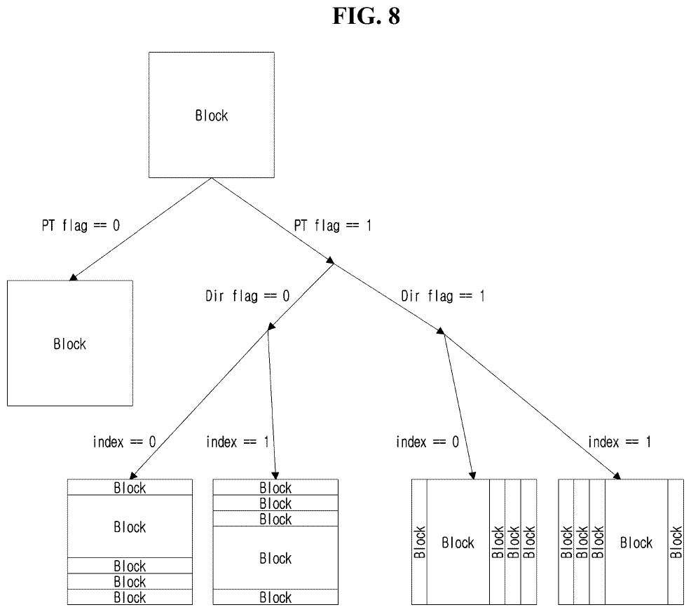

Alternatively, a plurality of PT partition types may include only two types among a first type to a third type. For example, a plurality of PT partition types may be configured with only a second type (1:4:1:1:1) and a third type (1:1:1:4:1) and partition may be performed only with one of a second type or a third type. In this case, an index belongs to a scope of 0 to 1. FIG. 8 shows an example related to it.

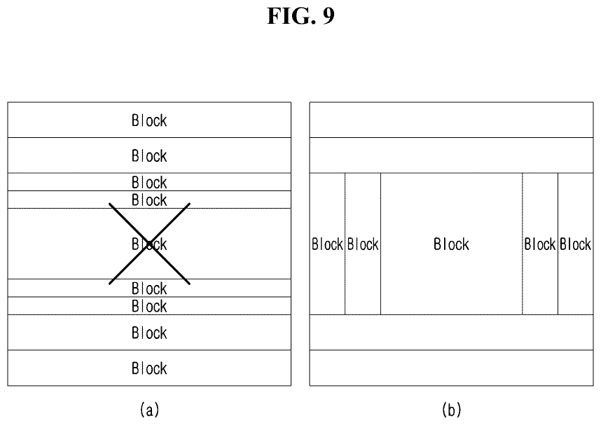

In an example of FIGS. 7 and 8, when the largest block among five blocks according to PT partition is additionally partitioned, a limitation on a partition direction may be applied. In an example, when a parent block is partitioned in a horizontal direction, only partition in a vertical direction may be allowed for a child block. FIG. 9 is an example in which the above-mentioned limitation is applied. In FIG. 7, when a parent block is partitioned by using PT flag=0, Dir flag=0 and index=0 and PT partition is additionally applied to the largest child block, partition in a horizontal direction is not allowed as shown in FIG. 9(a) and only partition in a vertical direction is allowed as shown in FIG. 9(b). Or conversely, when the largest child block is additionally partitioned, a method of applying a partition direction of a parent block as it is is also possible. In two examples above, signaling of a dir flag may be omitted for the largest child block and a dir flag of the largest child block may be derived by using a dir flag of a parent block. Also in an example of FIG. 8, the above-described limitation may be equally applied. Alternatively, the above-described limitation may be also equally applied to the remaining four child blocks of the same size.

As another example, additional partition may be allowed only for the largest child block among five child blocks (i.e., a child block with a ratio of 4). In this case, for the largest child block, application of PT partition is not allowed, but application of at least one of a BT, a TT or a QT may be allowed. In this case, the above-described limitation may be also applied to BT, TT or QT partition. In an example, BT, TT or QT partition may be forced to be applied only in a direction different from a PT partition direction of a parent block. Alternatively, additional PT partition may be allowed even for the largest child block. But, it may be allowed in a limited manner only when a size of the largest child or parent block is greater than or equal to a predetermined threshold size. Here, a size may be expressed as a width, a height, a ratio of a width and a height, a product of a width and a height, the minimum/maximum value of a width and a height, etc. A threshold size may be an integer of 4, 8, 16, 32, 64, 128, 256 or more.

Alternatively, for small child blocks among child blocks, application of PT partition is not allowed, but application of at least one of a BT, a TT or a QT may be allowed. In this case, the above-described limitation may be also equally applied to small child blocks. In an example, BT, TT or QT partition may be forced to be applied only in a direction different from a PT partition direction of a parent block.

Alternatively, the above-described limitation may be applied only to the largest child block and the above-described limitation may not be applied to small child blocks. Conversely, the above-described limitation may not be applied to the largest child block and the above-described limitation may be applied only to small child blocks. Alternatively, the above-described limitation may be applied only when a size of a parent block or a child block according to PT partition is smaller than or equal to a predetermined threshold size. Conversely, the above-described limitation may be applied only when a size of a parent block or a child block according to PT partition is greater than or equal to a predetermined threshold size. Since a size and a threshold size here are the same as described above, a detailed description will be omitted.

Whether PT partition is allowed may be determined by at least one of a size, a shape or a depth of a block. In an example, PT partition may be allowed only for a coding tree block or may be allowed only for a block with a size of 128×128, 64×64 or 32×32 or more. Alternatively, PT partition may be allowed only when the minimum value of a width or a height of a block is greater than or equal to 128, 64 or 32. Alternatively, PT partition may be allowed only for a square block and may not be allowed for a non-square block. Alternatively, PT partition may be allowed depending on a size regardless of a shape of a block.

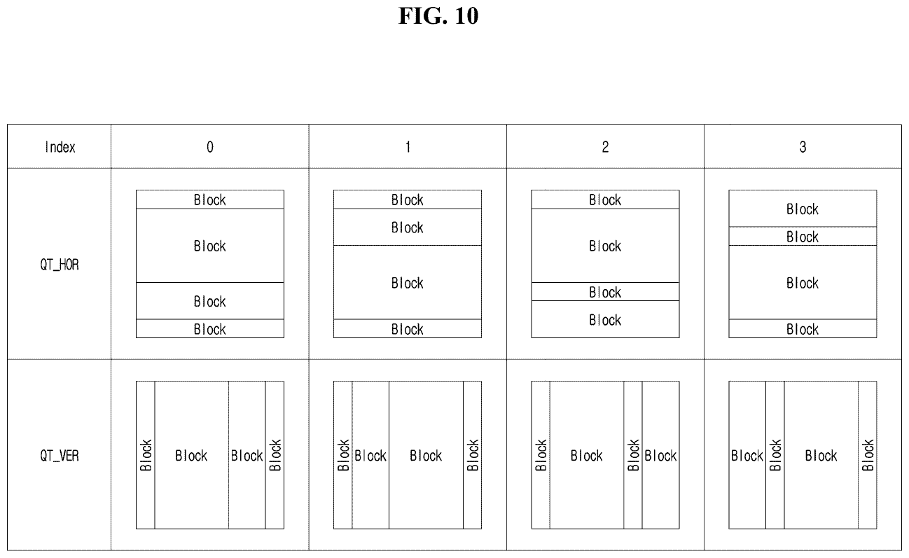

A parent block may be partitioned into four parts only in one of a horizontal direction or a vertical direction, which is hereinafter referred to as a modified four-partition method. A parent block may be asymmetrically partitioned into four child blocks. Here, at least one of four child blocks may be partitioned to have a size different from the other one. For example, a partition type according to a modified four-partition method may be defined as shown in FIG. 10. A partition type of index 0 is a type of partitioning a width or a height of a parent block at a ratio of 1:4:2:1, a partition type of index 1 is a type of partitioning a width or a height of a parent block at a ratio of 1:2:4:1, a partition type of index 2 is a type of partitioning a width or a height of a parent block at a ratio of 1:4:1:2 and a partition type of index 3 is a type of partitioning a width or a height of a parent block at a ratio of 2:1:4:1. FIG. 10 shows four partition types as a partition type according to a modified four-partition method, but it is just an example, and a partition type according to a modified four-partition method may be configured with only part, not all, of four partition types. Alternatively, a partition type according to a modified four-partition method may further include a partition type that partition is performed so that four child blocks have the same size through symmetric partition. Any one of a plurality of partition types may be selectively used and for this purpose, index information may be encoded/decoded. Index information may be encoded and transmitted in an encoding device or may be derived based on a predetermined encoding parameter in a decoding device. An encoding parameter may refer to a partition type or a size of a higher block having a depth smaller than a parent block, a size or a position of a parent block, etc.

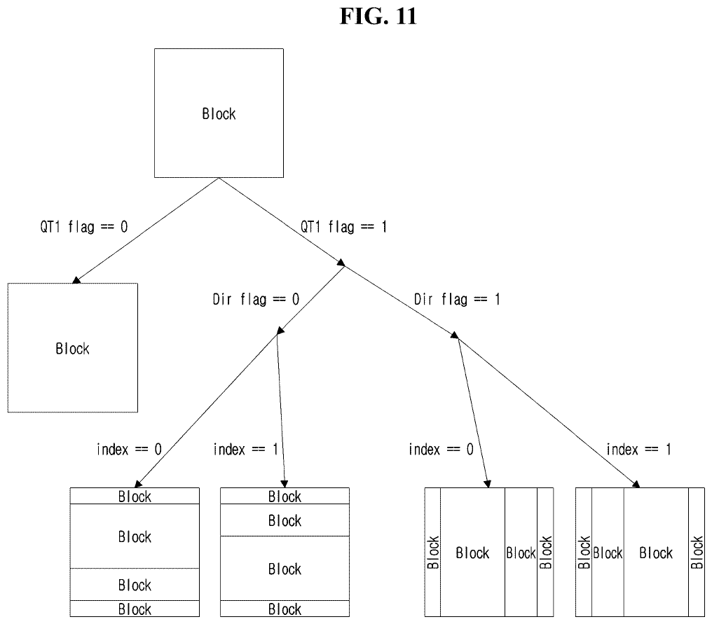

FIG. 11 shows a partition method for a case when a partition type according to a modified four-partition method (QT1) is configured with only partition types of index 0 to 1 shown in FIG. 10.

Whether to partition a block is determined through a QT1 flag. For example, when a QT1 flag is 0, partition is terminated without being performed. On the other hand, when a QT1 flag is 1, a Dir flag indicating a partition direction is used to determine whether partition will be performed in a horizontal direction or in a vertical direction. In addition, a partition type is indicated by additionally using an index and a parent block may be partitioned at a ratio of 1:4:2:1 or 1:2:4:1 according to an index value.

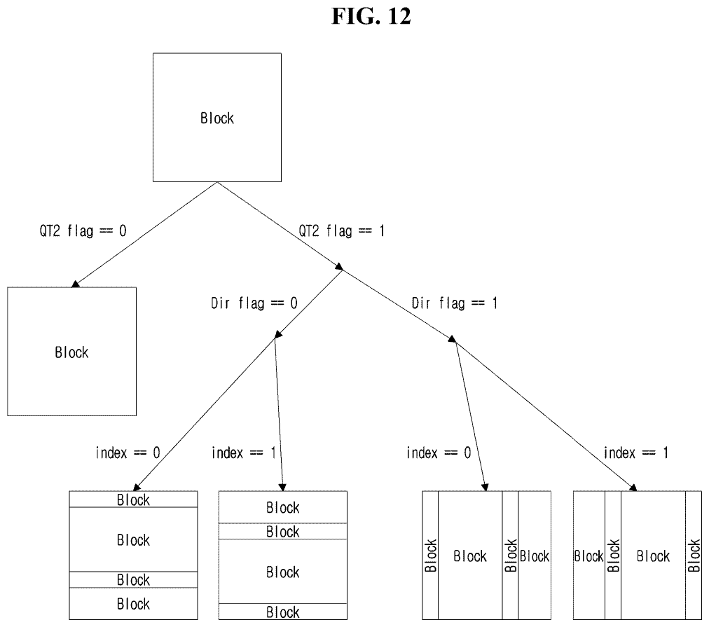

Alternatively, a four-partition method (QT2) different from that in FIG. 11 is also possible. FIG. 12 is an example showing it.

FIG. 12 shows a partition method for a case when a partition type according to a modified four-partition method (QT2) is configured with only partition types of index 2 to 3 shown in FIG. 10.

Whether to partition a block is determined through a QT2 flag. For example, when a QT2 flag is 0, partition is terminated without being performed. On the other hand, when a QT2 flag is 1, a Dir flag indicating a partition direction is used to determine whether partition will be performed in a horizontal direction or in a vertical direction. In addition, a partition type is indicated by additionally using an index and a parent block may be partitioned at a ratio of 1:4:1:2 or 2:1:4:1 according to an index value.

Even in a modified four-partition method, a limitation may be applied to a partition direction in a way similar to PT partition seen in FIG. 9. In an example, assume that a parent block is partitioned at a ratio of 1:4:2:1 in a horizontal direction and a child block with a ratio of 4 or 2 is additionally partitioned. In this case, a child block with a ratio of 4 or 2 may be partitioned by using a Dir flag of a parent block without signaling of a Dir flag. In an example, a partition direction of a child block may be determined as a direction different from that of a parent block. Alternatively, the limitation may be applied only to a block with a ratio of 4 and the limitation may be also applied only to a block with a ratio of 2. Alternatively, the limitation may be also applied only to a block with a ratio of 1. Alternatively, the limitation may be applied only to a block with a ratio of 4 and 2 and the limitation may not be applied to a block with a ratio of 1. Alternatively, the above-described limitation may be applied only when a size of a parent block or a child block according to a modified four-partition method is smaller than or equal to a predetermined threshold size. Conversely, the above-described limitation may be applied only when a size of a parent block or a child block according to a modified four-partition method is greater than or equal to a predetermined threshold size. Since a size and a threshold size here are the same as described above, a detailed description will be omitted.

As another example, additional partition may be allowed only for at least one of a block with a ratio of 4 or a block with a ratio of 2 among child blocks. In an example, at least one of a BT, TT, QT, PT or modified four-partition method may be applied to a child block above. In this case, the above-described limitation may be also applied to a BT, TT, QT, PT or modified four-partition method. In an example, a BT, TT, QT, PT or modified four-partition method may be forced to be applied only in a direction different from a PT partition direction of a parent block.

Alternatively, additional partition may be allowed for small child blocks of child blocks (i.e., a block with a ratio of 1). In this case, the above-described limitation may be also applied to small child blocks.

Whether a modified four-partition method is allowed may be determined by at least one of a size, a shape or a depth of a block. In an example, a modified four-partition method may be allowed only for a coding tree block or may be allowed only for a block with a size of 128×128, 64×64 or 32×32 or more. Alternatively, a modified four-partition method may be allowed only when the minimum value of a width or a height of a block is greater than or equal to 128, 64 or 32. Alternatively, a modified four-partition method may be allowed only for a square block and may not be allowed for a non-square block. Alternatively, a modified four-partition method may be allowed depending on a size regardless of a shape of a block.

Information indicating whether to use tree partition methods such as the above-described BT, TT, QT, PT and modified four-partition method may be signaled to a decoding device through a higher header such as a video parameter set (VPS), a sequence parameter set (SPS), a picture parameter set (PPS), a picture header (PH) and a slice header (SH), respectively.

Alternatively, information indicating whether to use these tree partition methods may be signaled to a decoding device per region where parallel processing is performed, respectively.

The above-described tree partition methods may be used interchangeably with priority. A priority may be signaled per higher header or region where parallel processing is performed.

At least one of the above-described partition methods may be applied when a coding block is partitioned into a plurality of coding blocks. Alternatively, at least one of the above-described partition methods may be applied when a coding block is partitioned into a plurality of prediction blocks or may be applied when a coding block is partitioned into a plurality of transform blocks. Alternatively, at least one of the above-described partition methods may be applied when one prediction block is partitioned into a plurality of sub-blocks for prediction in a unit of a sub-block. Alternatively, at least one of the above-described partition methods may be applied when one transform block is partitioned into a plurality of sub-blocks for transform in a unit of a sub-block.

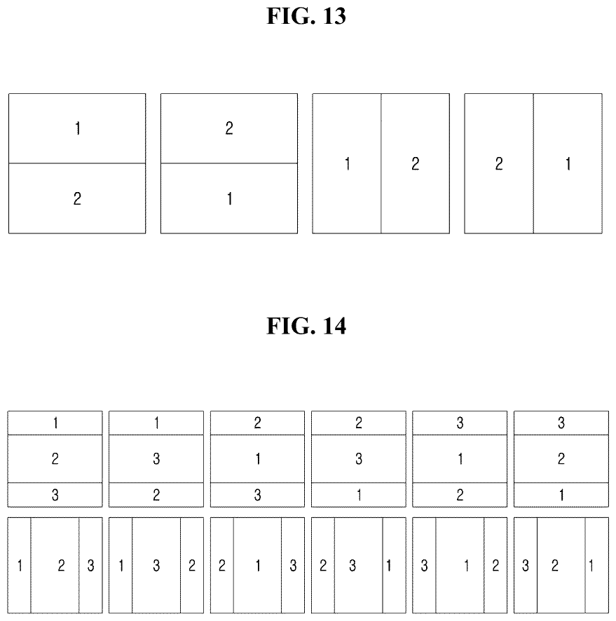

FIGS. 13 to 17 show encoding order according to a block partition method according to the present disclosure.

Partition information according to the present disclosure may additionally include encoding order between child blocks other than a block partition method using a partition flag. Hereinafter, when a parent block is partitioned into child blocks through tree partition, an example of coding order information (COI) of child blocks is described.

FIG. 13 shows encoding order which may be used for BT partition.

In FIG. 13, a number allocated to each block represents encoding order. As described in FIG. 3, when a BT flag is configured as 1 and partition is performed, information representing encoding order of a child block may be additionally signaled. When a BT flag is 0, partition into child blocks is not performed, so there is no need to signal information representing encoding order. The number of encoding orders available according to a partition method is expressed as a value of (partition direction)×(number of partitions)! and for BT partition, it becomes 2×2! (i.e., 4).

FIG. 14 shows encoding order which may be used for TT partition.

In FIG. 14, a number allocated to each block represents encoding order. As described in FIG. 5, when a TT flag is configured as 1 and partition is performed, information representing encoding order of a child block may be additionally signaled. When a TT flag is 0, partition into child blocks is not performed, so there is no need to signal information representing encoding order. For TT partition, the number of available encoding orders becomes 2×3! (i.e., 12).

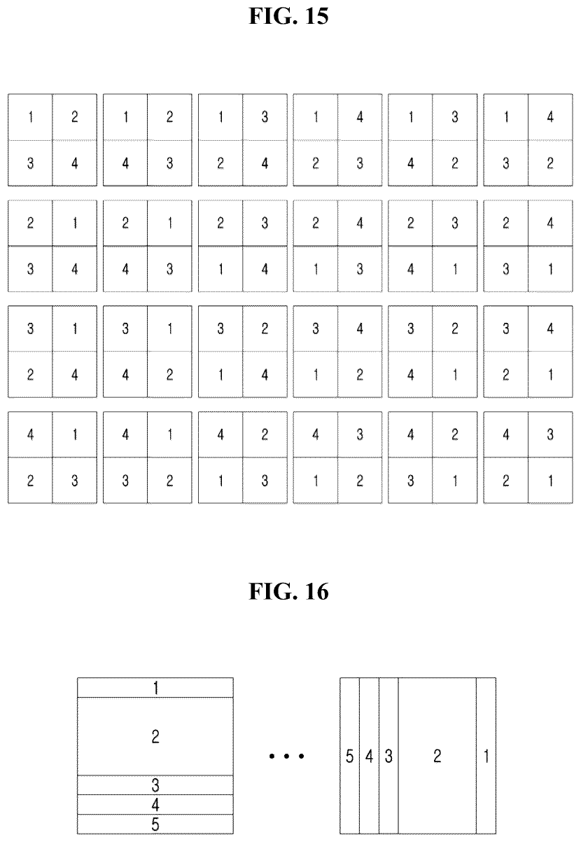

FIG. 15 shows encoding order which may be used for QT partition.

In FIG. 15, a number allocated to each block represents encoding order. As described in FIG. 6, when a QT flag is configured as 1 and partition is performed, information representing encoding order of a child block may be additionally signaled. When a QT flag is 0, partition into child blocks is not performed, so there is no need to signal information representing encoding order. QT partition refers to partition into four parts, and there is no partition direction, so the number of available encoding orders becomes 1×4! (i.e., 24).

Also for PT partition, similarly to the above-described method, when a PT flag is configured as 1 and partition is performed, information representing encoding order of a child block may be additionally signaled. When a PT flag is 0, partition into child blocks is not performed, so there is no need to signal information representing encoding order. PT partition refers to partition into five parts, and partition in a horizontal or vertical direction is performed, so the number of available encoding orders becomes 2×5! (i.e., 240). FIG. 16 is an example showing some of 240 encoding orders.

Also in an example of FIG. 8, FIG. 11 or FIG. 12, in the same manner as the above-described method, information representing encoding order may be signaled only when partition is performed. Likewise, the number of available encoding orders may be also calculated as (partition direction)×(number of partitions)!.

Alternatively, for simplicity, as in FIG. 13 to FIG. 16, all available encoding orders may not be used as a candidate. In an example, an encoding direction may be signaled according to a partition direction. An encoding direction may be configured as at least one of a left-to-right, right-to-left, top-to-bottom, bottom-to-top, diagonal or reverse diagonal direction. In an example, when a block is partitioned into two parts as in FIG. 13, an encoding direction may be signaled according to whether it is partitioned in a horizontal direction or in a vertical direction. When a block is partitioned horizontally, in which direction of a top-to-bottom direction or a bottom-to-top direction encoding is performed may be signaled. Conversely, when a block is partitioned vertically, in which direction of a left-to-right direction or a right-to-left direction encoding is performed may be signaled. Likewise, the same contents may be also applied to FIG. 14 to FIG. 16.

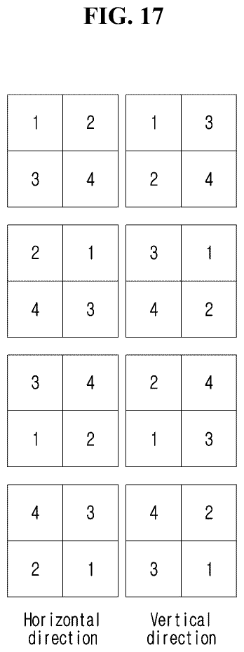

As another example, an encoding start position and/or end position or an encoding start position and/or progress direction may be signaled. In an example, unlike an example of FIG. 15, when QT partition is applied, a zigzag scan method is always used, but only an encoding start position and progress direction may be signaled. FIG. 17 shows an example related to it.

In an example of FIG. 17, information indicating a block with the first encoding order and information representing whether a progress direction is horizontal or vertical may be encoded.

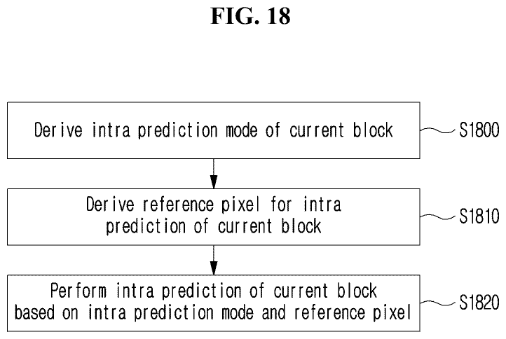

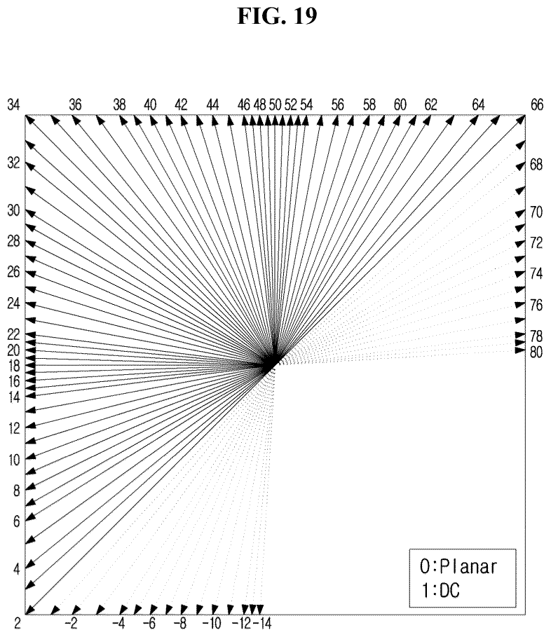

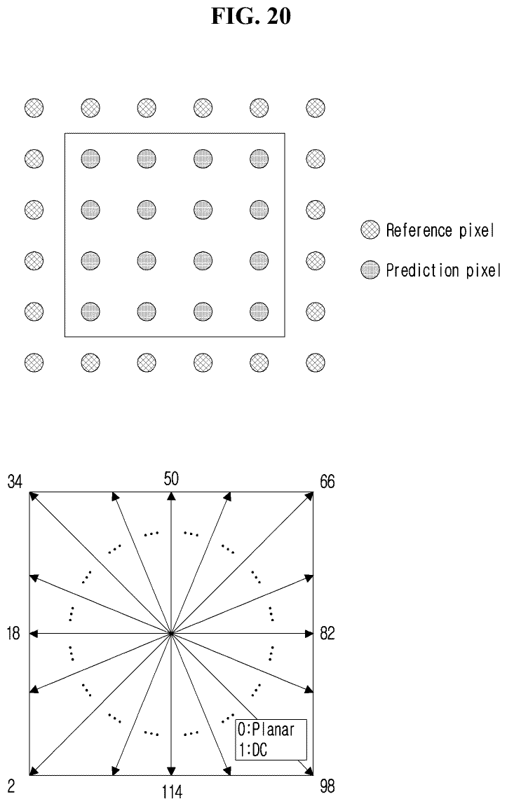

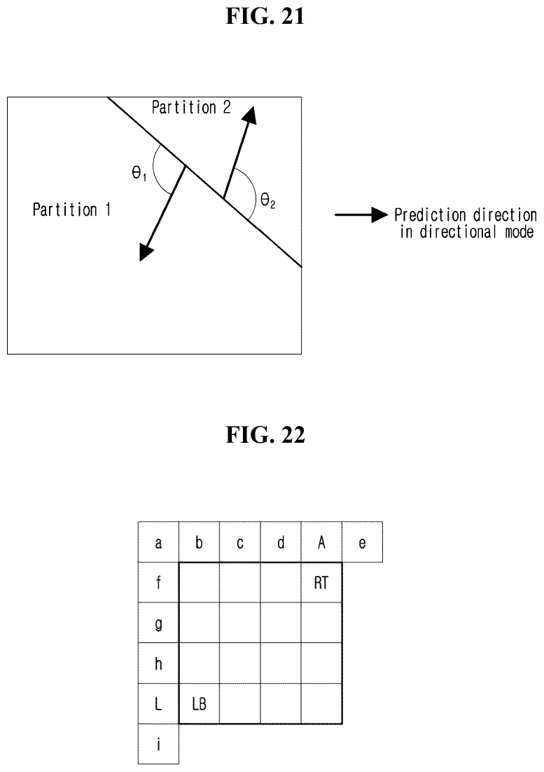

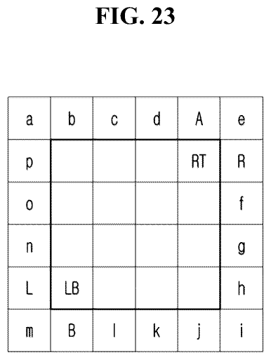

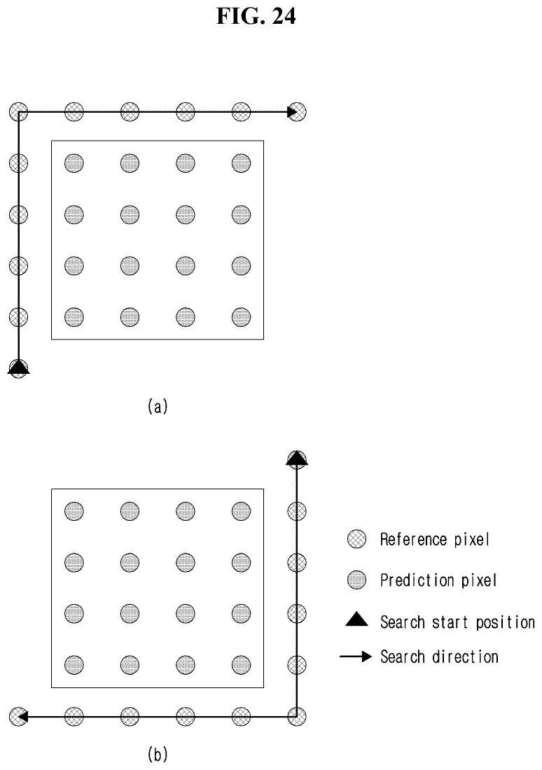

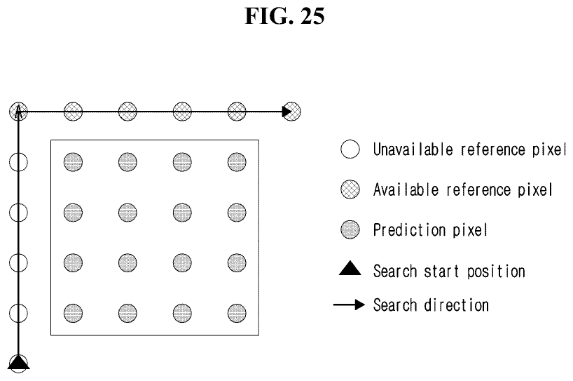

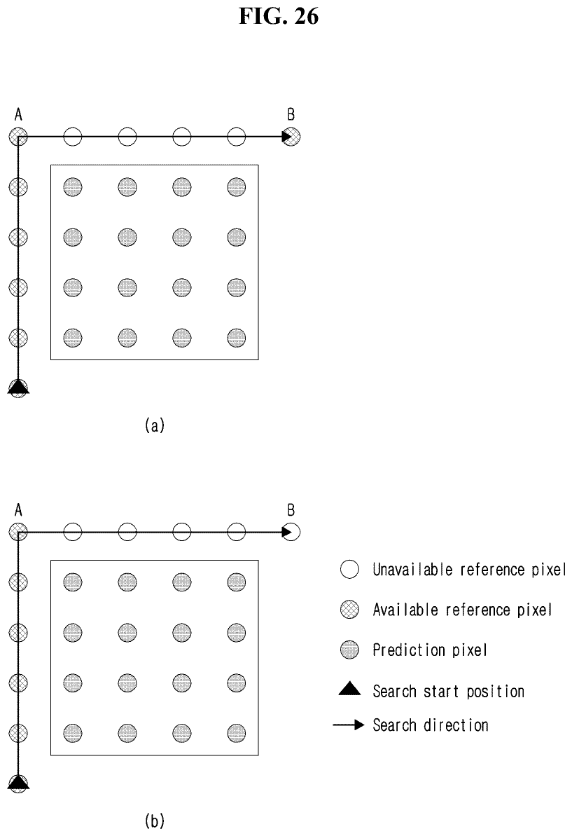

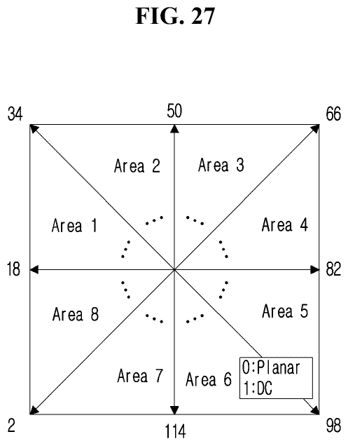

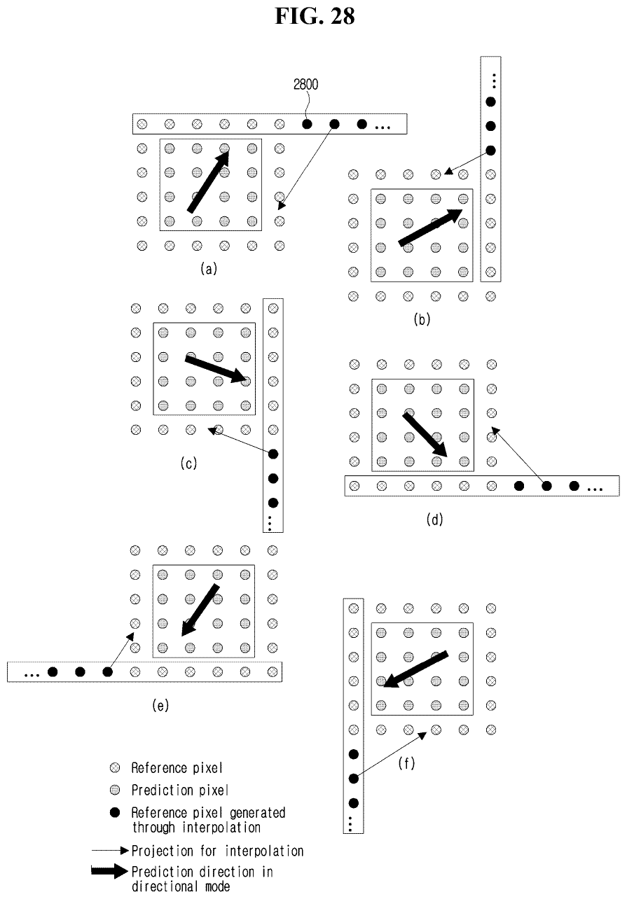

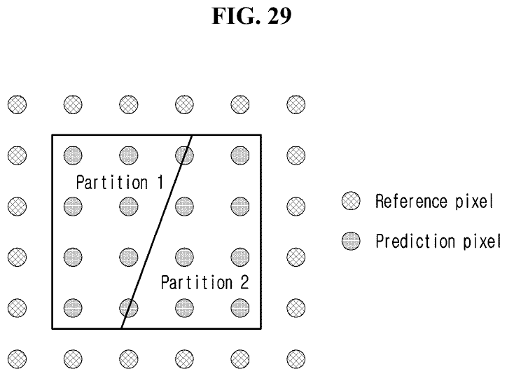

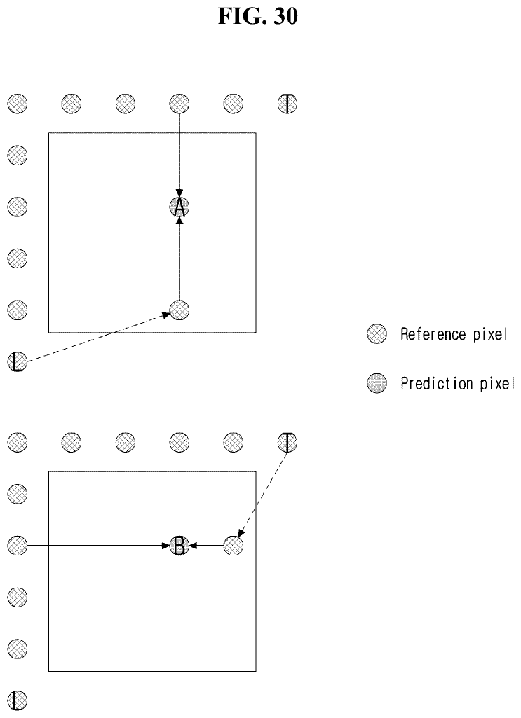

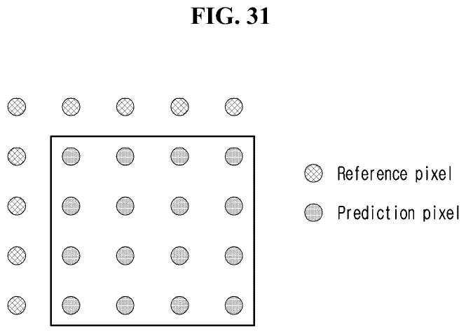

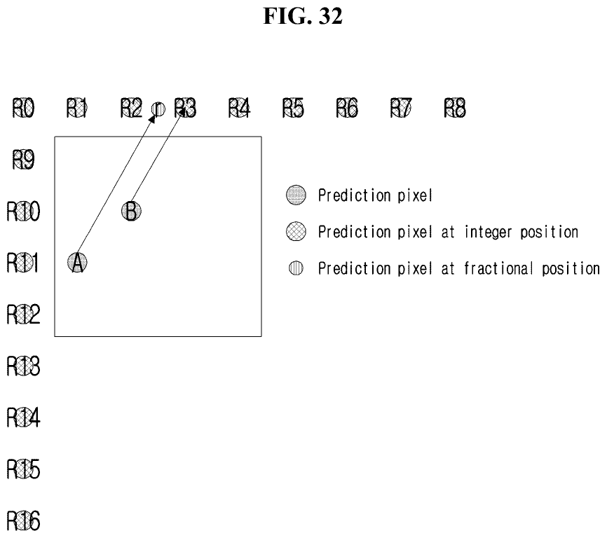

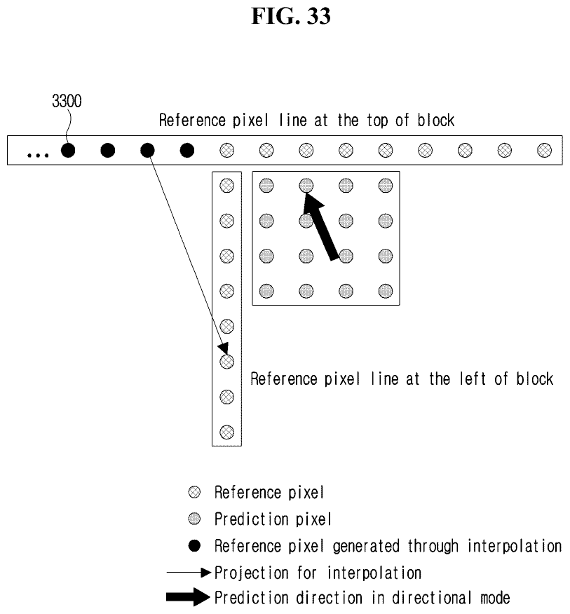

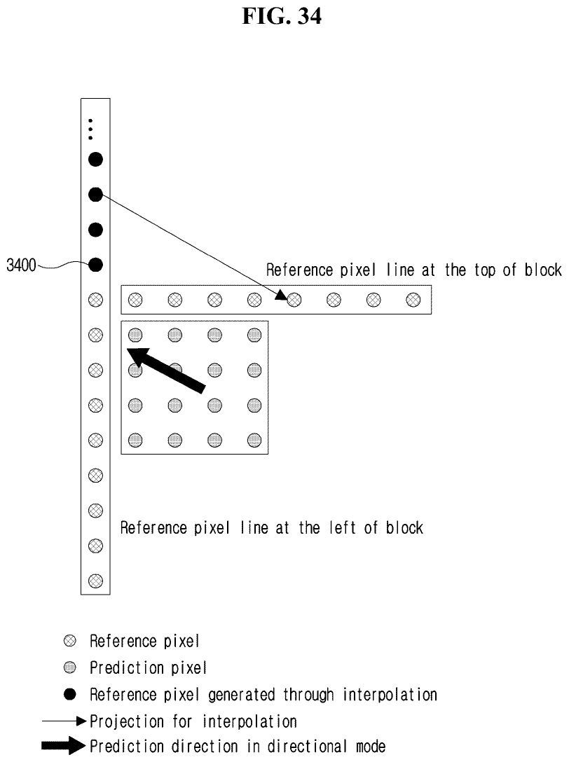

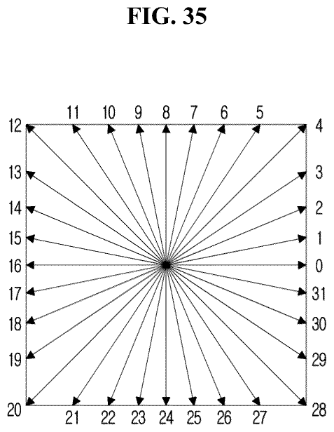

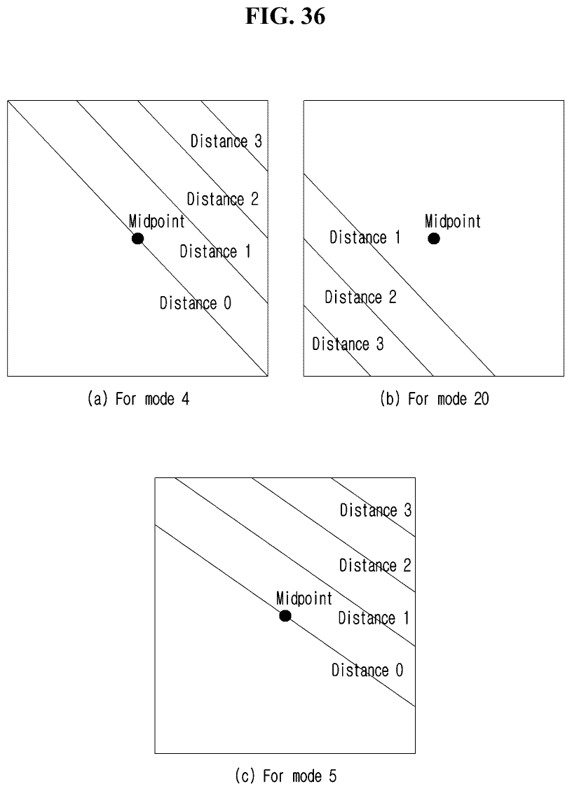

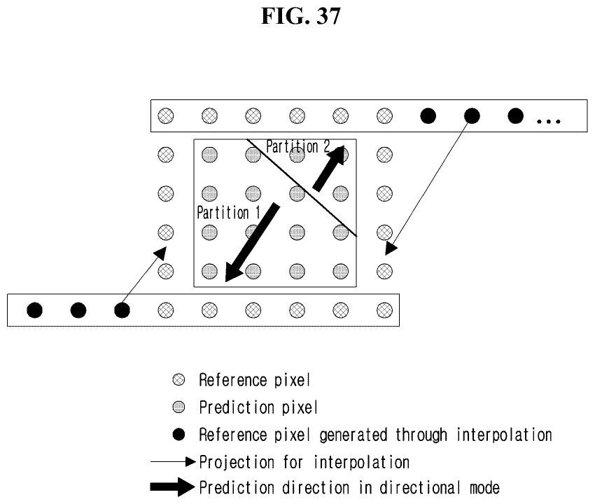

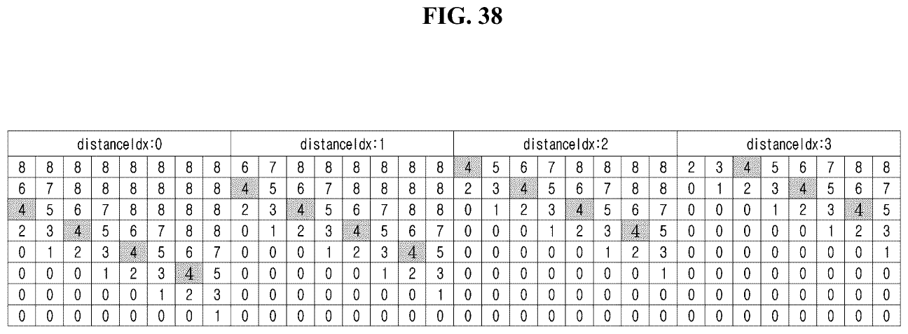

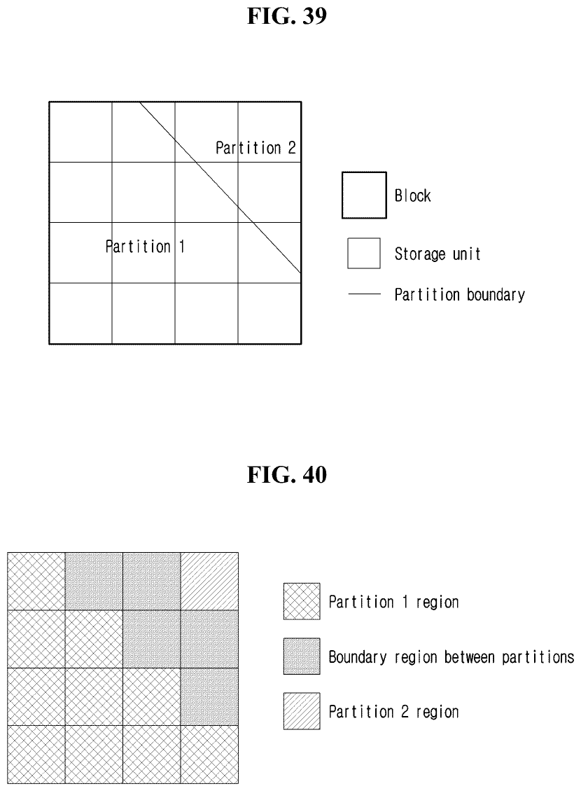

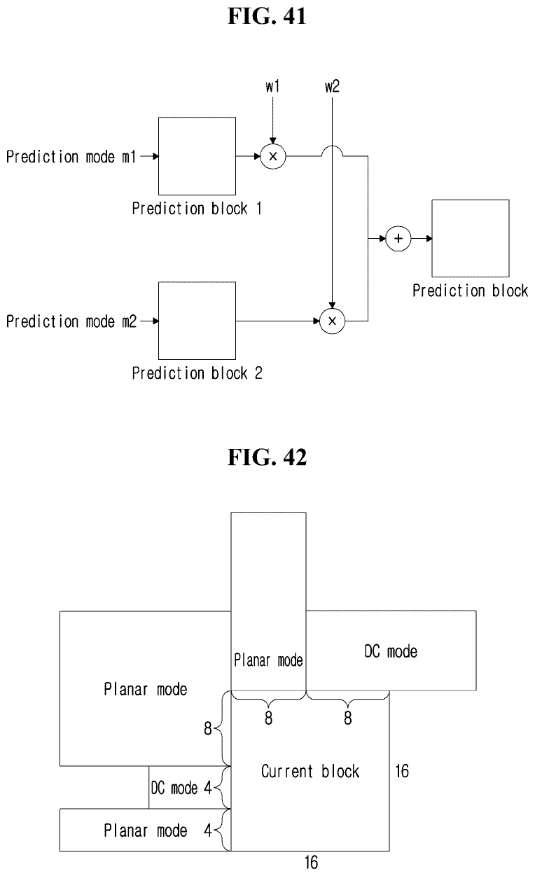

FIG. 18 shows an intra prediction method in an encoding/decoding device according to the present disclosure.

A block may be encoded by applying intra prediction, a technology of removing redundant data which exists spatially. When intra prediction is applied, a prediction block configured with prediction values (prediction pixels) for an original block is generated by using a surrounding pixel adjacent to an original block or a pixel belonging to a line N away from an original block as a reference pixel. Afterwards, a residual block, a difference value between an original block and a prediction block, is generated to remove redundant data.

In reference to FIG. 18, an intra prediction mode of a current block may be derived S1800.

Here, a current block may be obtained by partitioning a coding block based on at least one of the above-described partition methods. An intra prediction mode may be derived as one of intra prediction modes which are predefined in an encoding/decoding device.

FIGS. 19 and 20 show predefined intra prediction modes available for a current block.

In reference to FIG. 19, number 0 is allocated to a prediction method using a plane, which is referred to as a planar mode or mode 0. In addition, number 1 is allocated to a prediction method using DC, which is referred to as a DC mode or mode 1. For other methods using directivity (directional mode), number from −14 to 80 is allocated and a direction is indicated with an arrow. In an example, mode 18 represents a prediction method using a horizontal direction and mode 50 represents a prediction method using a vertical direction.

According to coding order information (COI) information described above, an available reference pixel may be expanded around a block to be encoded. Accordingly, a reference pixel around a block may exist not only on the left and top of a block, but also on the right and/or bottom of a block. Accordingly, an intra prediction mode using a reference pixel on the right and/or bottom may be additionally defined. FIG. 20 shows an example in which a directional mode of FIG. 19 is expanded in full 360 degrees. Here, unlike FIG. 19, a directional mode is expressed as number 2 to 129 for convenience of a description.

A current block may be partitioned into a plurality of partitions. Partition here may be performed based on at least one of the above-described partition methods. In this case, according to a partition type of a current block or a size or a shape of a partition, a scope of an intra prediction mode which may be used by each partition may be adjusted. FIG. 21 shows an example related to it.

In FIG. 21, a scope of θ₁ and θ₂ may be adjusted. In an example, each of θ₁ and θ₂ may have a value between A degrees and B degrees. A value of A and B may be signaled through a higher header or may have a preconfigured value in an encoding/decoding device.

Alternatively, an angle range may be determined according to a partition direction. For example, when a current block is partitioned in a 45-degree direction at a top-left position, partition 1 may be configured not to use an intra prediction mode which exceeds 45 degrees and partition 2 may be configured not to use an intra prediction mode which is less than 45 degrees.

In the example, a case in which a directional mode is applied to diagonally partitioned partitions was described. Similar to a directional mode, a planar mode or a DC mode may be also applied to diagonally partitioned partitions.

Alternatively, a planar mode or a DC mode may be also configured not to be applied to diagonally partitioned partitions.

Alternatively, if one of two partitions is a planar mode or a DC mode, a directional mode may be configured to be applied to one remaining partition all the time. Alternatively, the opposite case is also possible.

Alternatively, if one of two partitions is a planar mode or a DC mode, a DC mode or a planar mode may be configured to be applied to one remaining partition all the time. Alternatively, the opposite case is also possible.

When an intra prediction mode is encoded, an index specifying one of a plurality of MPM candidates belonging to a MPM list may be signaled after configuring a most probable mode (MPM) list. A decoding device may configure a MPM list in the same way as an encoding device and derive an intra prediction mode of a current block based on a MPM list and a signaled index.

FIGS. 22 and 23 show a surrounding reference position used when configuring a MPM list.

A surrounding reference position shown in FIGS. 22 and 23 may mean one pixel or block, respectively. It is assumed that the surrounding reference position is included in a different block around a current block.

In reference to FIG. 22, LB refers to a position of a pixel at a bottom-leftmost position in a current block and RT refers to a position of a pixel at a top-rightmost position in a current block. In an example, a MPM list may be configured by using intra prediction modes existing in a block including L and a block including A. Afterwards, an intra prediction mode of a current block may be signaled by using information indicating whether an intra prediction mode of a current block is included in a MPM list, index information (MPM index) indicating the same mode in a MPM list or information specifying one of the remaining modes if it is not included in a MPM.

Alternatively, a MPM list may be configured by using an intra prediction mode of at least one of a block including a sample (h or g) at a left-middle position and a block including a sample (d or c) at a top-center position. Alternatively, a MPM list may be configured by using an intra prediction mode of at least one of a block including a sample (f) at a top-left position and a block including a sample (b) at a top-left position.

In addition, when a reference pixel at a right and bottom position of a current block is available, a MPM according to FIG. 22 may be expanded. Specifically, a MPM candidate may be derived by using at least one of a neighboring block adjacent to the right of a current block and/or a neighboring block adjacent to the bottom of a current block.

In FIG. 23, LB refers to a position of a pixel at a bottom-leftmost position in a current block and RT refers to a position of a pixel at a top-rightmost position in a current block. In an example, a MPM list may be configured by using intra prediction modes existing in a block including L and a block including A. Alternatively, a MPM list may be configured by using an intra prediction mode existing in at least one of a block including R and a block including B.

Alternatively, a MPM list may be configured by using a bottom block including at least one of a bottom-center (k or l) sample or a bottom-right (j) sample or by using a right block including at least one of a right-middle (g or f) sample or a bottom-right (h) sample.

Alternatively, only one representative mode among intra prediction modes of surrounding blocks at a right and bottom position described above may be added to a MPM list. Here, a representative mode may refer to the minimum value, the maximum value or a mode among intra prediction modes of surrounding blocks at a right and bottom position and may refer to a mode at a fixed position pre-promised in an encoding/decoding device.

A right block and/or a bottom block may be used to derive a MPM candidate instead of a left block and/or a top block. Alternatively, a MPM candidate may be derived by further using at least one of a right block or a bottom block along with a left and/or top block.

When a current block is partitioned into a plurality of partitions, a plurality of partitions may share one intra prediction mode. Alternatively, an intra prediction mode may be derived per each partition of a current block.

An intra prediction mode of two partitions may be configured to be derived only through a MPM candidate. In other words, when a current block is partitioned into a plurality of partitions, an intra prediction mode of each partition may have the same value as one of a plurality of MPM candidates. In this case, encoding/decoding of a MPM flag is omitted, and its value may be considered as 1 (infer). In addition, a MPM index may be signaled for each of a plurality of partitions.

Alternatively, an intra prediction mode of a first partition may be derived based on a MPM candidate, while an intra prediction mode of a second partition may be configured as a default mode. A default mode may include at least one of a planar mode, a DC mode, a vertical mode, a horizontal mode or a diagonal mode. When a plurality of default modes are defined, one of a plurality of default modes may be selectively used. Index information for the selection may be signaled and a mode with the highest priority among a plurality of default modes may be used. A priority may be given in order of a planar mode, a DC mode, a vertical mode (or a horizontal mode) and a diagonal mode, but it is not limited thereto.

Alternatively, an intra prediction mode of a second partition may be derived by adding/subtracting an offset to/from an intra prediction mode of a first partition. Here, an offset may be predefined in an encoding/decoding device. Alternatively, offset information (e.g., an absolute value and/or a sign) may be encoded and signaled.

In addition, an intra prediction mode used per each partition may be signaled. In this case, after configuring a most probable mode (MPM) list to encode intra prediction modes, index information specifying one of a plurality of MPM candidates belonging to a MPM list may be signaled per each partition. In an example, an intra prediction mode of a first partition may be determined by a first MPM index and an intra prediction mode of a second partition may be determined by a second MPM index. In this case, when a MPM index of a second partition is greater than a MPM index of a first partition, a value obtained by subtracting 1 from a MPM index of a second partition may be encoded/decoded as a second MPM index. In other words, when an intra prediction mode of a second partition is equal to or greater than an intra prediction mode of a first partition, an intra prediction mode of a second partition may be derived by using a MPM index obtained by adding 1 to a second MPM index.

A flag representing whether an intra prediction mode of a second partition is derived based on an intra prediction mode of a first partition may be defined. Here, when a flag is a first value, an intra prediction mode of a second partition may be derived based on an intra prediction mode of a first partition and when a flag is a second value, an intra prediction mode of a second partition may be derived based on the above-described default mode or may be derived based on index information signaled for a second partition.

Alternatively, a flag representing whether an intra prediction mode of a second partition is derived based on a default mode may be defined. Here, when a flag is a first value, an intra prediction mode of a second partition may be derived based on the above-described default mode and when a flag is a second value, an intra prediction mode of a second partition may be derived based on index information signaled for a second partition.

Alternatively, a MPM list may be generated per partition. In an example, a first MPM list for a first partition and a second MPM list for a second partition may be generated. In this case, at least one of neighboring blocks for a first MPM list may be different from one of neighboring blocks for a second MPM list. In an example, a first MPM list may be generated by using a left and top neighboring block and a second MPM list may be generated by using a right and bottom neighboring block. Alternatively, when a second MPM list is generated, it may be also generated by using only candidates different from candidates existing in a first MPM list. The number of neighboring blocks available for configuring a first MPM list may be different from the number of neighboring blocks available for configuring a second MPM list. The number of neighboring blocks available for configuring a first MPM list may be N and the number of neighboring blocks available for configuring a second MPM list may be (N+1) or more. Here, a first partition refers to a partition including a top-left sample or a top-right sample in a current block and N may be 2, 3, 4 or more.

Two or more intra prediction modes may be derived for a current block. In an example, two intra prediction modes m1 and m2 may be encoded by using a MPM list and signaled, respectively.

Alternatively, only intra prediction modes existing in a MPM list may be used. In this case, m1 and m2 may be signaled by using a MPM index, respectively.

Alternatively, although it is not included in a MPM list, an intra prediction mode which exists around a current block may be used and then, it may be designated as an index and used.

Alternatively, a priority may be given to a specific mode. In an example, a planar mode or a DC mode may be configured to be always used for m1. Afterwards, contrary to m1, a DC mode or a planar mode may be configured to be used for m2. In this case, only information representing whether m1 is a planar mode or a DC mode may be signaled.

Alternatively, a method of allocating a planar mode or a DC mode only to one mode of m1 and m2 and using other intra prediction mode for the remaining modes is also possible.

Alternatively, it is also possible to always use a fixed mode for m1. In an example, a fixed mode may be a planar mode or a DC mode. In this case, only an intra prediction mode used for m2 is informed by being signaled to a decoding device.

Alternatively, both m1 and m2 may be a fixed mode. In an example, two fixed modes may be a planar mode and a DC mode, respectively. Alternatively, in a directional mode, two modes with a 180-degree difference may be configured as m1 and m2, respectively.

Alternatively, a method of preconfiguring a set of modes which may be used for m1 and m2 is also possible. Table 1 is an example related to the set.

TABLE 1

| Set Index | m1 | m2 |
|---|---|---|
| 0 | Planar Mode | DC Mode |
| 1 | Planar Mode | Vertical Mode |
| 2 | DC Mode | Vertical Mode |
| 3 | Planar Mode | Horizontal Mode |
| 4 | DC Mode | Vertical Mode |
| 5 | Vertical Mode | Horizontal Mode |
| . . . | . . . | . . . |

Afterwards, as in Table 1, a set index may be signaled to inform a decoder of an intra prediction mode used for m1 and m2.

When a current block is partitioned into a plurality of partitions, a method of deriving a plurality of intra prediction modes for a current block has been described, which may be equally applied when m1 and m2 are derived and a detailed description will be omitted.

In reference to FIG. 18, a reference pixel for intra prediction of a current block may be derived S1810.

Reference pixels of a current block may be derived from a reference pixel line which is adjacent to a current block (hereinafter, referred to as an adjacent pixel line) or may be derived from a reference pixel line which is not adjacent to a current block (hereinafter, referred to as a non-adjacent pixel line). Alternatively, some of reference pixels of a current block may be derived from an adjacent pixel line and others may be derived from a non-adjacent pixel line. Here, a non-adjacent pixel line may refer to all or part of P reference pixel lines which are predefined in an encoding/decoding device.

There may be a reference pixel which is unavailable due to a reason such as encoding order of a block, a case in which a boundary of a block is positioned at a boundary of an image (e.g., a picture, a tile, a slice, a CTU raw), etc. Accordingly, at a corresponding position, a reference pixel should be generated through a padding process.

Padding may be performed by dividing a surrounding region of a current block into two regions. In an example, the left and top of a current block may be configured as a first region and the right and bottom may be configured as a second region. First, a search start position is configured per each region to determine whether a reference pixel is available. FIG. 24 is an example showing a search start position and a search direction per each region. FIG. 24(a) shows a first region including reference pixels on the left and top of a current block and FIG. 24(b) shows a second region including reference pixels on the bottom and right of a current block.

In an example, in FIG. 24(a), if a search start position is configured, it is checked whether there is an available reference pixel at a search start position. If it does not exist, search is performed sequentially in a search direction until an available reference pixel is searched. FIG. 25 shows an example of a search process.

In FIG. 25, it is an example in which an available reference pixel is searched first at a position of A while performing search in a search direction from a search start position. After an available reference pixel is searched at a position of A, a reference pixel at a position of A is copied to a search start position. Afterwards, padding is performed by sequentially copying a copied reference pixel to a position just before A in a search direction. In other words, when a pixel at a search start position is unavailable, an available pixel which is found first may be padded to a search start position.

Unlike an example above, there may be a reference pixel which is unavailable after a search start position. FIG. 26 shows an example related to it.

In reference to FIG. 26(a), when an unavailable reference pixel exists at the middle position of a reference pixel line, interpolation is performed on a reference pixel present at a position of A and B to perform padding. In other words, when a N-th pixel is unavailable, a corresponding pixel may be generated through interpolation between an available pixel found last before N and an available pixel found first after N.

As in FIG. 26(b), when there is no available reference pixel from a middle point to an end point of a reference pixel line, padding is performed by sequentially copying a reference pixel existing at the nearest position A to position B. In other words, when all pixels after a N-th pixel are unavailable, padding is performed by copying a (N−1)-th pixel to a last position.

Alternatively, a method of conducting search in a search direction from a search start position, determining a first available reference pixel as a reference pixel, copying this reference pixel to all unavailable positions and performing padding is also possible.

The above-described method may be also applied in the same/similar manner to a region like FIG. 24(b).

When all reference pixels in a first region are unavailable, padding may be performed by using a preconfigured value. In an example, when all reference pixels are unavailable, padding may be performed on a reference pixel by using an intermediate value using a bit depth. In an example, when a bit depth of a pixel is 10 bits, a scope of a pixel value may be 0 to 1023 and an intermediate value may be 512.

Additionally, when all reference pixels in a second region are unavailable, padding may be performed on a reference pixel by using an intermediate value using a bit depth. In an example, when a bit depth of a pixel is 10 bits, a scope of a pixel value may be 0 to 1023 and an intermediate value may be 512.

A reference pixel which may be used on all four sides (left, right, top and bottom) of a current block may be generated through the above-described padding method.

Alternatively, when padding is performed in each region, a pixel in other region may be used. In an example, when padding of a second region is performed, a pixel existing in a first region may be used. Conversely, when padding of a first region is performed, a pixel existing in a second region may be also used.

When a reference pixel exists on all four sides of a current block, a simplified reference pixel may be used depending on a directional mode. In reference to FIG. 27, according to an area to which a directional mode belongs, only one reference pixel line of a left reference pixel line, an upper reference pixel line, a right reference pixel line and a lower reference pixel line may be used. In FIG. 27, a number of an intra prediction mode is expressed as 0 to 129, and number 0 and number 1 represent a planar mode and a DC mode, respectively, and number 2 to number 129 represent a directional mode.

FIG. 28(a) to (f) are an example of a method of using one reference pixel line when an intra prediction mode belongs to area 3 to area 8, respectively.

As shown in FIG. 28, reference pixels may be rearranged in an one-dimensional way. A pixel 2800 may be generated by copying a pixel at a projected position in parallel with a directional mode or may be generated by interpolating surrounding integer pixels at a projected position.

FIG. 29 is an example showing a surrounding reference pixel which may be used for intra prediction when a current block is partitioned into a plurality of partitions.

In addition, according to a scope of θ₁ and θ₂ configured FIG. 21, a reference pixel line which may be used per each partitioned partition may be the same or different.

In reference to FIG. 18, intra prediction may be performed based on a reference pixel and an intra prediction mode of a current block S1820.

Hereinafter, in reference to FIGS. 30 to 34, a method in which a prediction pixel is generated per intra prediction mode will be described in detail.

FIG. 30 is an example showing a method of generating a prediction pixel in a planar mode.

In FIG. 30, T and L are an example of a surrounding reference pixel used when generating a prediction pixel in a planar mode. T represents a reference pixel at a position of a top-right corner and L represents a reference pixel at a position of a bottom-left corner. Here, A is a prediction pixel for a vertical direction. A may be generated by performing linear interpolation on a reference pixel and L at the same position as A on a Y-axis. B is a prediction pixel for a horizontal direction. B may be generated by performing linear interpolation on a reference pixel and T at the same position as B on a X-axis. Here, A and B are at the same position in a block. Afterwards, a final prediction pixel is generated by using Equation 1, i.e., by performing a weighted sum of A and B.

$$( α \times A \times β \times B ) / ( α + β ) \qquad [ Equation 1 ]$$

In this case, weight a and B may be the same value in Equation 1. Alternatively, weight α and β may be adaptively determined according to a position of a pixel. The above-described method is applied to all pixel positions in a block to generate a prediction block using a planar mode.

FIG. 31 is an example showing a method of generating a prediction pixel in a DC mode.

As in FIG. 31, after calculating an average value of reference pixels existing around a block, a calculated value is configured as all prediction pixels in a prediction block. Reference pixels used when calculating an average value may include reference pixels at a top, left and top-left position of a block. Alternatively, an average value may be calculated by using only reference pixels adjacent to the top and left (i.e., excluding a reference pixel at a top-left position).

Alternatively, according to a shape of a block, an average value may be calculated by using only top reference pixels or left reference pixels. In an example, when a horizontal length of a current block is longer than a vertical length, an average value may be calculated by using only top reference pixels. Alternatively, even when a horizontal length of a current block is longer than a vertical length, an average value may be calculated by using only top reference pixels when a horizontal length is less than or equal to a predetermined threshold size, and an average value may be calculated by using at least one top-right reference pixel other than top reference pixels when a horizontal length is larger than a predetermined threshold size. Alternatively, even when a horizontal length of a current block is longer than a vertical length, an average value may be calculated by using only top reference pixels adjacent to a current block when a horizontal length is less than or equal to a predetermined threshold size, and an average value may be calculated by using at least one top-right reference pixel which is not adjacent to a current block other than top reference pixels adjacent to a current block when a horizontal length is greater than a predetermined threshold size. On the other hand, when a vertical length of a current block is longer than a horizontal length, an average value may be calculated by using only left reference pixels. Likewise, even when a vertical length of a current block is longer than a horizontal length, an average value may be calculated by using only left reference pixels when a vertical length is less than or equal to a predetermined threshold size, and an average value may be calculated by using at least one bottom-left reference pixel other than left reference pixels when a vertical length is greater than a predetermined threshold size. Alternatively, even when a vertical length of a current block is longer than a horizontal length, an average value may be calculated by using only left reference pixels adjacent to a current block when a vertical length is less than or equal to a predetermined threshold size, and an average value may be calculated by using at least one left reference pixel which is not adjacent to a current block other than left reference pixel adjacent to a current block when a vertical length is greater than a predetermined threshold size. Alternatively, the opposite case is also possible.

According to the above-described method, all values of a prediction pixel in a block are the same in a DC mode.

In a directional mode, projection is performed in a reference direction according to an angle of each directional mode. When a reference pixel exists at a corresponding position, a corresponding reference pixel is configured as a prediction pixel. If a reference pixel does not exist at a corresponding position, a pixel at a corresponding position is generated by interpolating a surrounding reference pixel and an interpolated pixel is configured as a prediction pixel. FIG. 32 shows an example therefor.

In an example above, for prediction pixel B, when projection is performed at a corresponding position in a reference direction according to an angle of an intra prediction mode, a reference pixel at an integer position exists (a reference pixel at an integer position, R3). In this case, a corresponding reference pixel is configured as a prediction pixel. For prediction pixel A, when projection is performed at a corresponding position in a reference direction according to an angle of an intra prediction mode, a reference pixel at an integer position does not exist (i.e., a projected position indicates a reference pixel at a fractional position). In this case, after interpolation is performed by using reference pixels at a surrounding integer position, an interpolated value (a reference pixel at a fractional position, r) is configured as a prediction pixel.

When intra prediction using a directional mode is performed as in an example of FIG. 32, a position of a reference pixel in a specific mode may be changed to simplify implementation. In an example, for mode 2 to mode 18 in FIG. 19, only a reference pixel existing on the left of a block is used and for mode 50 to mode 66, only a reference pixel existing on the top of a block is used. But, for mode 19 to mode 49, all reference pixels existing on the left and top of a block should be used. In this case, according to a position of a prediction pixel to be generated in a block, which reference pixel line of a left or top reference pixel line should be used should be determined. To simplify this process, only a reference pixel line in one direction may be used according to a directional mode. FIG. 33 is an example of an intra prediction method for a case in which a directional mode is one of number 34 to number 49.

When a directional mode is one of number 34 to number 49, only a top reference pixel line may be used by giving a priority to a top reference pixel line of a block. In this case, in order to generate a reference pixel 3300 of a top reference pixel line in FIG. 33, projection is performed on a left reference pixel line in a direction parallel to a directional mode. A left reference pixel at a projected position may be configured as a reference pixel 3300. In this case, when a projected position is a fractional position, not an integer position, reference pixels at an integer position adjacent to a corresponding fractional position are interpolated to generate a pixel at a fractional position. Afterwards, a prediction pixel in a block is generated by using only a top reference pixel line.

Meanwhile, FIG. 34 is an example of an intra prediction method for a case in which a directional mode is one of number 19 to number 33. In this case, a reference pixel 3400 of a left reference pixel line may be derived based on a top reference pixel designated by performing projection at a position of a reference pixel 3400 in a direction parallel to a directional mode. It is the same as described by referring to FIG. 33, and a detailed description will be omitted.

A current block may be partitioned into a plurality of partitions by one or more partition lines crossing a current block. The partition line may be specified based on a partition direction and a distance from the center of a current block. FIG. 35 shows a partition direction of a partition line partitioning a current block into a plurality of partitions and FIG. 36 shows a distance from the center of a current block.

In other words, a partition line may be a diagonal line, an oblique line, a horizontal line or a vertical line, etc. In reference to FIG. 35, index 0 to index 31 may be allocated according to a partition direction or a partition angle. But, FIG. 35 is just an example of a partition direction, and fewer than 32 partition directions may be used to reduce complexity or more than 32 partition directions may be used to improve prediction accuracy. According to a size or a shape of a current block, the number and type of available partition directions may vary.

A non-rectangular partition may be configured in a unit of prediction performance (e.g., a prediction unit). In other words, a reference pixel region and/or an intra prediction mode (e.g., a directional prediction mode) may be determined per partitioned partition. In order to specify a partition line, at least one of information representing a distance from the center of a current block and/or a partition angle may be encoded/decoded.

In FIG. 36, (a) and (b) are a mode facing each other at an angle. Accordingly, in order to prevent an overlapping partition type, a case in which a distance is 0 may be defined in only one of (a) and (b). In this example, it is assumed that mode 0 to mode 15 may have only distance 0 to distance 3 and mode 16 to mode 31 may have only distance 1 to distance 3. In an example, for mode 4, partition is performed in a top-right direction, so partition like FIG. 36(a) may be performed. Accordingly, for diagonal partition of a block, one of partition directions defined in FIG. 35 and one of distances defined in FIG. 36 are required. Information on this partition direction and distance may be signaled in a unit of a block.

FIG. 37 shows an example for a method of obtaining a prediction pixel by using a different intra prediction mode per each partition of a current block.

When a current block is partitioned into two partitions by the above-described partition line, a different intra prediction mode may be used per each partition. In this case, discontinuity may exist at a boundary between partitions. Accordingly, a weight matrix may be used to apply smoothing to a boundary between partitions. Here, a weight matrix may be adaptively derived based on at least one of a size/a shape of a current block, a partition direction (or a partition angle) of a partition line partitioning a current block or a distance from the center of a current block to a partition line.

Specifically, a first prediction block of a current block may be generated based on an intra prediction mode of a first partition and a second prediction block of a current block may be generated based on an intra prediction mode of a second partition, respectively. Here, a first prediction block and a second prediction block have the same size as a current block. A final prediction block of a current block may be obtained by applying a weight matrix to each of a first prediction block and a second prediction block. In this case, a prediction pixel of a first partition in a final prediction block is filled with pixels of a first prediction block corresponding thereto and a prediction pixel of a second partition in a final prediction block is filled with pixels of a second prediction block corresponding thereto. But, a prediction pixel at a boundary and/or near a boundary between partitions may be filled with a weighted sum of a pixel of a first prediction block and a pixel of a second prediction block.

FIG. 38 shows an example of a weight matrix applied to a 8×8 block. This example shows a weight matrix according to mode 5 in FIG. 35. In addition, distanceIdx: 0 to 3 in FIG. 38 refers to distance 0 to distance 3 in FIG. 36.

A weight is determined per pixel position in a current block, a weighted sum is performed by using Equation 2 below and a final prediction block is generated.

$$P [ x ] [ y ] = ( w [ x ] [ y ] * P 0 [ x ] [ y ] + ( {W}_{Max} - w [ x ] [ y ] ) * P 1 [ x ] [ y ] + offset ) ≫ shift \qquad Equation 2$$

$$shift = Log 2 ( {W}_{max} )$$

$$offset = 1 ≪ ( shift - 1 )$$

In Equation 2, P0 refers to a first prediction block generated based on an intra prediction mode of a first partition and P1 refers to a second prediction block generated based on an intra prediction mode of a second partition. w refers to a weight matrix, W_{Max} refers to a sum of the maximum value and the minimum value of a weight existing in a weight matrix and shift and offset refer to a normalization constant. Accordingly, in this example, W_{Max} becomes 8 and accordingly, a shift value becomes 3 and an offset value becomes 4.

A current block encoded by intra prediction may be inserted into a MPM list as a MPM candidate when encoding a block to be encoded later. Accordingly, one or more intra prediction modes used for intra prediction of a current block may be stored in a buffer. An intra prediction mode may be stored per storage unit in a current block. FIGS. 39 and 40 are an example showing a storage unit of a current block which is partitioned into two partitions and encoded.

In FIG. 39, a set of storage units may become a block and a storage unit may become a block in a 1×1 (pixel unit) or N×N size. Here, N may be an integer of 2, 4 or more. Hereinafter, it is described by assuming that a size of a storage unit is 1×1.

In reference to FIG. 40, a storage unit may be expressed as three regions according to a partition boundary. Here, a region is a set of storage units.

In FIG. 40, an intra prediction mode used in a first partition is stored in a first partition and an intra prediction mode used in a second partition is stored in a second partition. But, all intra prediction modes used in a first partition and a second partition are stored in a boundary region between partitions.

Alternatively, only one mode of two intra prediction modes may be stored in a boundary region between partitions. In an example, based on a size between partitions, one of two intra prediction modes may be selectively stored. In an example of FIG. 40, an intra prediction mode used in a first partition is stored in a boundary region between partitions. Alternatively, the opposite case is also possible.

Alternatively, based on a priority between intra prediction modes of partitions, only one mode of two intra prediction modes may be stored. In an example, when both a nondirectional mode and a directional mode are used for a current block, a nondirectional mode may be stored in a boundary region between partitions. Alternatively, based on a priority between directional modes, an intra prediction mode which will be stored in a boundary region between partitions may be determined.

Alternatively, for simplicity, an intra prediction mode stored in a boundary region between partitions may be always an intra prediction mode used for a first partition. Alternatively, it is also possible to always store an intra prediction mode used for a second partition.

Alternatively, only one representative mode may be stored in the entire current block. Here, a representative mode may be configured as an intra prediction mode of a partition with a large size or may be configured as an intra prediction mode used for a first partition. Or, the opposite case is also possible.

Alternatively, when a current block is partitioned into a plurality of partitions and encoded, a pre-promised fixed mode may be stored in the entire current block. In an example, a fixed mode may be a planar mode or a DC mode.

FIG. 41 shows a method of generating a prediction pixel of a current block based on two intra prediction modes in a current block.

In reference to FIG. 41, for a current block, a first prediction block is generated by using intra prediction mode m1 and a second prediction block is generated by using intra prediction mode m2. Then, a final prediction block is generated by performing a weighted sum on a first prediction block and a second prediction block based on weight w1 and w2. Weight w1 of the same value is applied to all pixels of a first prediction block and similarly, weight w2 of the same value is applied to all pixels of a second prediction block.

In order to avoid a real number operation, a weight may be integerized and used. In an example, when a real number operation is performed, a sum of weight w1 and w2 becomes 1, but when integerization is performed by being multiplied by 8, a sum of w1 and w2 becomes 8. Hereinafter, it is described by assuming that a sum of w1 and w2 is 8.

In an example, averaging may be performed without signaling a weight. Alternatively, a method of preconfiguring a weight list and encoding a used weight into an index is also possible. Table 2 below shows an example of a weight list.

TABLE 2

| Weight Index | w1 | w2 |
|---|---|---|
| 0 | 4 | 4 |
| 1 | 5 | 3 |
| 2 | 3 | 5 |
| 3 | 6 | 2 |
| 4 | 2 | 6 |
| . . . | . . . | . . . |

As in Table 2, a weight index may be signaled to inform a decoding device of weight w1 and w2 applied to a first prediction block and a second prediction block.

According to an intra prediction mode, a weight may be implicitly determined. In an example, a larger weight may be given to a prediction block obtained in the same intra prediction mode as a neighboring block.

Alternatively, a larger weight may be also allocated according to an intra prediction mode used for a surrounding block. FIG. 42 shows a weight allocation method according to an intra prediction mode of a surrounding block. A size of a current block is assumed as 16×16.

In this case, a priority may be allocated according to the number of pixels adjacent to a current block. In FIG. 42, a planar mode is 20 (=8+4+4) and a DC mode is 12 (=8+4), so a large weight may be allocated to a planar mode and a small weight may be allocated to the remaining modes. Alternatively, a priority may be also allocated based on the number of intra modes, not the number of pixels. In FIG. 42, among intra prediction modes existing around a current block, the most intra prediction modes are a planar mode, which is three, so the highest priority may be allocated to a planar mode.

Alternatively, a weight may be allocated by giving a priority according to an intra prediction mode. In an example, if one mode of two intra prediction modes is a planar mode, a weight used for a planar mode may be configured to be larger than the remaining weights. Alternatively, if one mode of two intra prediction modes is DC mode, a weight used for a DC mode may be configured to be larger than the remaining weights. Alternatively, if two intra prediction modes are a planar mode and a DC mode, respectively, the same weight may be also allocated. Alternatively, if two intra prediction modes with a 180-degree difference in a directional mode are configured to m1 and m2, respectively, the same weight may be also allocated.

As in an example above, a block encoded by performing a weighted sum between blocks may be inserted into a MPM list as a MPM candidate when coding blocks to be encoded later. Accordingly, a block that a weighted sum was performed should store an intra prediction mode used. In this case, all of two intra prediction modes may be stored. Afterwards, when a block that a weighted sum was performed is selected by a MPM index in another block, an additional flag may be used to indicate which mode of two intra prediction modes was selected.

Alternatively, a single mode may be stored by giving a priority to a specific mode. A priority may be configured in order of a planar mode->a DC mode->other directional mode. In an example, if m1 and m2 are a planar mode and a DC mode, respectively, only a planar mode may be stored according to a priority.

Alternatively, as in FIG. 42, after a priority is adaptively allocated according to the number of pixels adjacent to a current block, a mode with the highest priority may be stored. Alternatively, a priority may be allocated based on the number of intra prediction modes, not the number of pixels. In an example above, among modes existing around a current block, the most modes are a planar mode, which is three, so the highest priority may be allocated to a planar mode.

Alternatively, an intra prediction mode of a prediction block to which a larger weight is applied among a first prediction block and a second prediction block may be stored.

Alternatively, when intra prediction mode m1 and m2 are specified by a MPM index, respectively, an intra prediction mode corresponding to a smaller value of two MPM indexes may be stored. Alternatively, contrary to the above, an intra prediction mode corresponding to a larger value of two MPM indexes may be stored.

Alternatively, when a current block is a block encoded through the above-described weighted sum, a single mode which is always fixed for a current block may be stored. In an example, a fixed single mode may be a planar mode or a DC mode.

In an example above, a weighted sum of two prediction blocks is described as an example, but a final prediction block may be also generated by performing a weighted sum on N prediction blocks which are more than two.

When embodiments described based on a decoding process or an encoding process are applied to an encoding process or a decoding process, it is included in a scope of the present disclosure. When embodiments described in predetermined order are changed in order different from a description, it is also included in a scope of the present disclosure.

The above-described disclosure is described based on a series of steps or flow charts, but it does not limit a time series order of the present disclosure and if necessary, it may be performed at the same time or in different order. In addition, each component (e.g., a unit, a module, etc.) configuring a block diagram in the above-described disclosure may be implemented as a hardware device or software and a plurality of components may be combined and implemented as one hardware device or software. The above-described disclosure may be recorded in a computer readable recoding medium by being implemented in a form of a program instruction which may be performed by a variety of computer components. The computer readable recoding medium may include a program instruction, a data file, a data structure, etc. solely or in combination. A hardware device which is specially configured to store and perform magnetic media such as a hard disk, a floppy disk and a magnetic tape, optical recording media such as CD-ROM, DVD, magneto-optical media such as a floptical disk and a program instruction such as ROM, RAM, a flash memory, etc. is included in a computer readable recoding medium. The hardware device may be configured to operate as one or more software modules in order to perform processing according to the present disclosure and vice versa. A device according to the present disclosure may have program instructions for storing or transmitting a bitstream generated by the above-described encoding method.

### INDUSTRIAL AVAILABILITY

The present disclosure may be used to encode/decode an image.

1-21. (canceled)

22. A method of decoding an image, the method comprising:
splitting a current block into a first partition and a second partition;
deriving a first intra prediction mode for the first partition and a second intra prediction mode for the second partition;
obtaining a first prediction block by performing a first intra prediction based on the first intra prediction mode;
obtaining a second prediction block by performing a second intra prediction based on the second intra prediction mode; and
obtaining a final prediction block based on a weighted sum of the first prediction block and the second prediction block,
wherein an intra prediction mode candidate list is constructed for each of the first partition and the second partition,
wherein the first intra prediction mode is derived from a first intra prediction mode candidate list constructed for the first partition, and
wherein the second intra prediction mode is derived from a second intra prediction mode candidate list constructed for the second partition.

23. The method of claim 22, wherein the first intra prediction mode candidate list and the second intra prediction mode candidate list are constructed based on an intra prediction mode of neighboring blocks adjacent to the current block.

24. The method of claim 23, wherein a number of neighboring blocks referred to construct the first intra prediction mode candidate list is different from a number of neighboring blocks referred to construct the second intra prediction mode candidate list.

25. The method of claim 22, wherein the neighboring blocks comprise a top neighboring block and a left neighboring block which are adjacent to the current block.

26. The method of claim 22, wherein the weighted sum of the first prediction block and the second prediction block is performed based on one of weight matrixes defined in a decoding apparatus.

27. The method of claim 26, wherein the one of weighted matrixes is selected based on a size of the current block.

28. The method of claim 22, wherein an angle and a distance of a partitioning line which splits the current block into the first partition and the second partition is determined based on information decoded from a bitstream.

29. A method of encoding an image, the method comprising:
splitting a current block into a first partition and a second partition;
deriving a first intra prediction mode for the first partition and a second intra prediction mode for the second partition;
obtaining a first prediction block by performing a first intra prediction based on the first intra prediction mode;
obtaining a second prediction block by performing a second intra prediction based on the second intra prediction mode; and
obtaining a final prediction block based on a weighted sum of the first prediction block and the second prediction block,
wherein an intra prediction mode candidate list is constructed for each of the first partition and the second partition,
wherein the first intra prediction mode is derived from a first intra prediction mode candidate list constructed for the first partition, and
wherein the second intra prediction mode is derived from a second intra prediction mode candidate list constructed for the second partition.

30. The method of claim 29, wherein the first intra prediction mode candidate list and the second intra prediction mode candidate list are constructed based on an intra prediction mode of neighboring blocks adjacent to the current block.

31. The method of claim 30, wherein a number of neighboring blocks referred to construct the first intra prediction mode candidate list is different from a number of neighboring blocks referred to construct the second intra prediction mode candidate list.

32. The method of claim 29, wherein the neighboring blocks comprise a top neighboring block and a left neighboring block which are adjacent to the current block.

33. The method of claim 29, wherein the weighted sum of the first prediction block and the second prediction block is performed based on one of weight matrixes defined in a decoding apparatus.

34. The method of claim 33, wherein the one of weighted matrixes is selected based on a size of the current block.

35. The method of claim 29, wherein an angle and a distance of a partitioning line which splits the current block into the first partition and the second partition is determined based on information decoded from a bitstream.

36. A device for transmitting compressed video data, comprising:
a processor configured to obtain the compressed video data; and
a transmitter configured to transmit the compressed video data,
wherein obtaining the compressed video data comprises:
splitting a current block into a first partition and a second partition;
deriving a first intra prediction mode for the first partition and a second intra prediction mode for the second partition;
obtaining a first prediction block by performing a first intra prediction based on the first intra prediction mode;
obtaining a second prediction block by performing a second intra prediction based on the second intra prediction mode; and
obtaining a final prediction block based on a weighted sum of the first prediction block and the second prediction block,
wherein an intra prediction mode candidate list is constructed for each of the first partition and the second partition,
wherein the first intra prediction mode is derived from a first intra prediction mode candidate list constructed for the first partition, and
wherein the second intra prediction mode is derived from a second intra prediction mode candidate list constructed for the second partition.
